(19) United States
(12) Patent Application Publication
(10) Pub. No.: US 2017/0300946 A1
(43) Pub. Date: Oct. 19, 2017

(54) VECTOR-BASED CHARACTERIZATIONS OF PRODUCTS

(71) Applicant: Wal-Mart Stores, Inc., Bentonville, AR (US)

(72) Inventors: Bruce W. Wilkinson, Rogers, AR (US); Brian G. McHale, Chadderton Oldham (GB); Todd D. Mattingly, Bentonville, AR (US)

(21) Appl. No.: 15/487,894

(22) Filed: Apr. 14, 2017

Related U.S. Application Data
(60) Provisional application No. 62/323,026, filed on Apr. 15, 2016.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.
(60) Provisional application No. 62/471,804, filed on Mar. 15, 2017.
(60) Provisional application No. 62/439,526, filed on Dec. 28, 2016.
(60) Provisional application No. 62/436,791, filed on Dec. 20, 2016.
(60) Provisional application No. 62/482,855, filed on Apr. 7, 2017.

(51) Int. Cl. G06Q 30/02; G06Q 50/00

(52) U.S. Cl. CPC G06Q 30/0204; G06Q 50/01

(57) ABSTRACT

Vectorized product characterizations can be based upon information that includes various characterizations of the corresponding products. This information can comprise objective information and/or subjective content as desired. Such information can be sourced, for example, by third-party product testing services, user-based product characterization sources (such as on-line consumer review sources), and otherwise as desired. One or more rules can be employed to automatically resolve conflicts between such characterizations before using such characterizations to form the corresponding vectorized product characterizations.

### CROSS-REFERENCE TO RELATED APPLICATION

This application claims the benefit of each of the following U.S. Provisional applications, each of which is incorporated herein by reference in its entirety: 62/323,026 filed Apr. 15, 2016 (Attorney Docket No. 8842-137893-USPR_1235US01); 62/348,444 filed Jun. 10, 2016 (Attorney Docket No. 8842-138849-USPR_3677US01); 62/436,842 filed Dec. 20, 2016 (Attorney Docket No. 8842-140072-USPR_3678US01); 62/485,045, filed Apr. 13, 2017 (Attorney Docket No. 8842-140820-USPR_4211US01); 62/471,804, filed Mar. 15, 2017 (Attorney Docket No. 8842-139753-USPR_2130US01); 62/439,526, filed Dec. 28, 2016 (Attorney Docket No. 8842-138370-USPR_1301US01); 62/436,791, filed Dec. 20, 2016 (Attorney Docket No. 8842-138779-USPR_1469US01); and 62/482,855, filed Apr. 7, 2017 (Attorney Docket No. 8842-139760-USPR_2136US01).

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. Existing preference-based approaches leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provisions of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 is an exemplary block diagram of a systems for collecting customer information in accordance with some embodiments;

FIG. 19 is an exemplary flow diagram of a method for collecting customer information in accordance with some embodiments;

FIG. 20 is an exemplary flow diagram of a method for collecting customer information in accordance with some embodiments;

FIG. 21 comprises a flow diagram as configured in accordance with various embodiments of these teachings;

FIG. 22 comprises a schematic representation as configured in accordance with various embodiments of these teachings;

FIG. 23 illustrates a simplified block diagram of an exemplary distributed retail partiality vector system, in accordance with some embodiments;

FIG. 24 illustrates a simplified flow diagram of a process of maintaining distributed partiality vectors, in accordance with some embodiments; and

FIG. 25 illustrates an exemplary system for use in implementing methods, techniques, devices, apparatuses, systems, servers, sources and providing access to rendered retail environments, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

The aforementioned vectorized product characterizations can be based upon information that includes various characterizations of the corresponding products. This information can comprise objective information and/or subjective content as desired. Such information can be sourced, for example, by third-party product testing services, user-based product characterization sources (such as on-line consumer review sources), and otherwise as desired. One or more rules can be employed to resolve conflicts between such characterizations before using such characterizations to form the corresponding vectorized product characterizations.

These teachings are highly flexible in practice. As one illustrative example, by one approach these teachings can comprise a network edge element that comprises at least one local sensor, a memory having partiality vector information for a person associated with that network edge element, and a control circuit operably coupled to the foregoing components and configured to download vectorized product characterizations from at least one remote resource and to use the partiality vector information and the vectorized product characterizations to identify at least one particular product for the person that accords with the partiality vector information for that person. By one approach the aforementioned network edge element can be configured to be personally carried by the person when operating in a deployed state. By another approach the aforementioned network edge element can be configured to not be personally carried by the person when operating in a deployed state.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

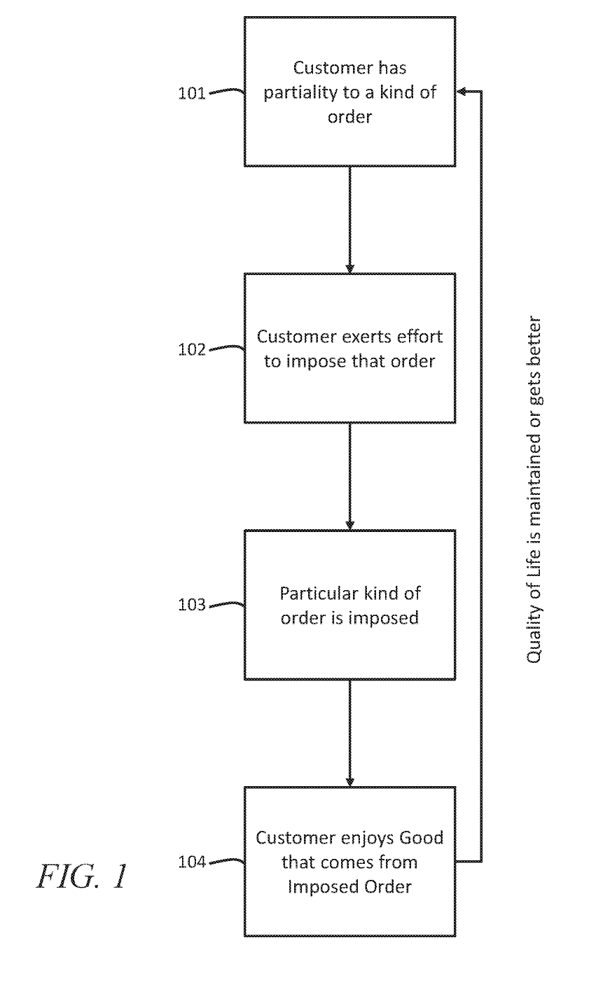

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

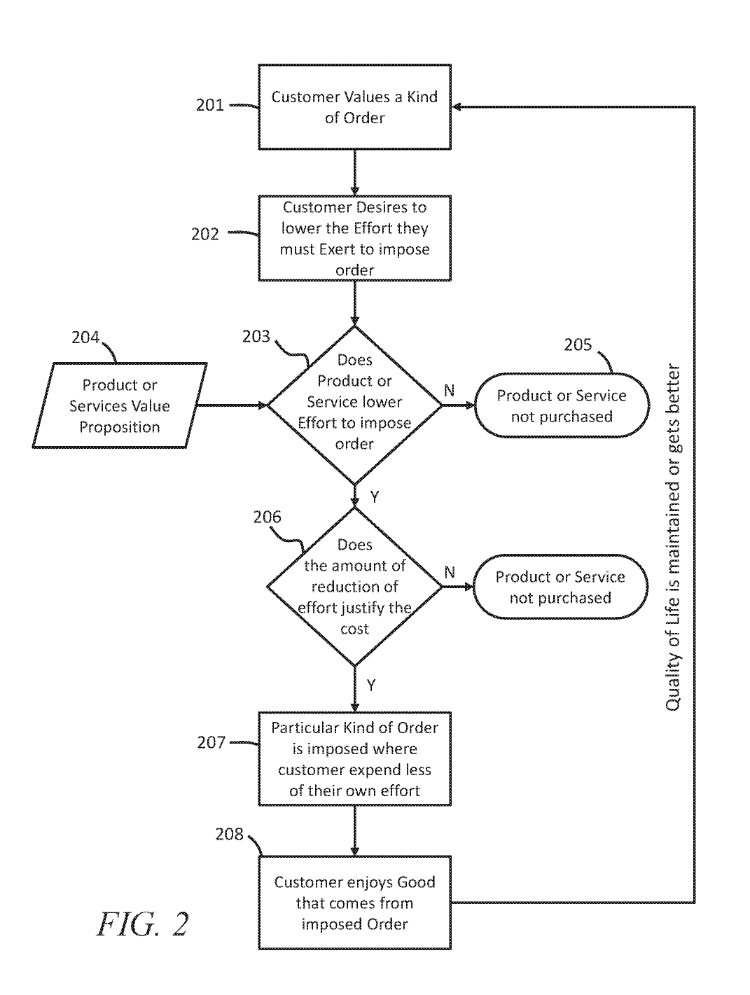

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

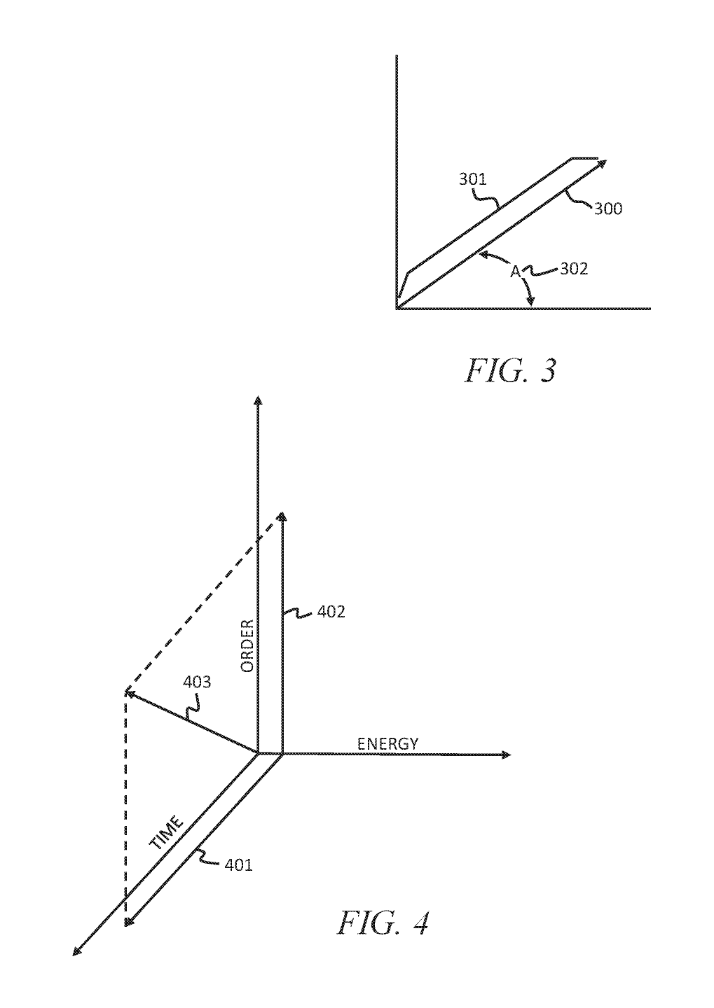

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

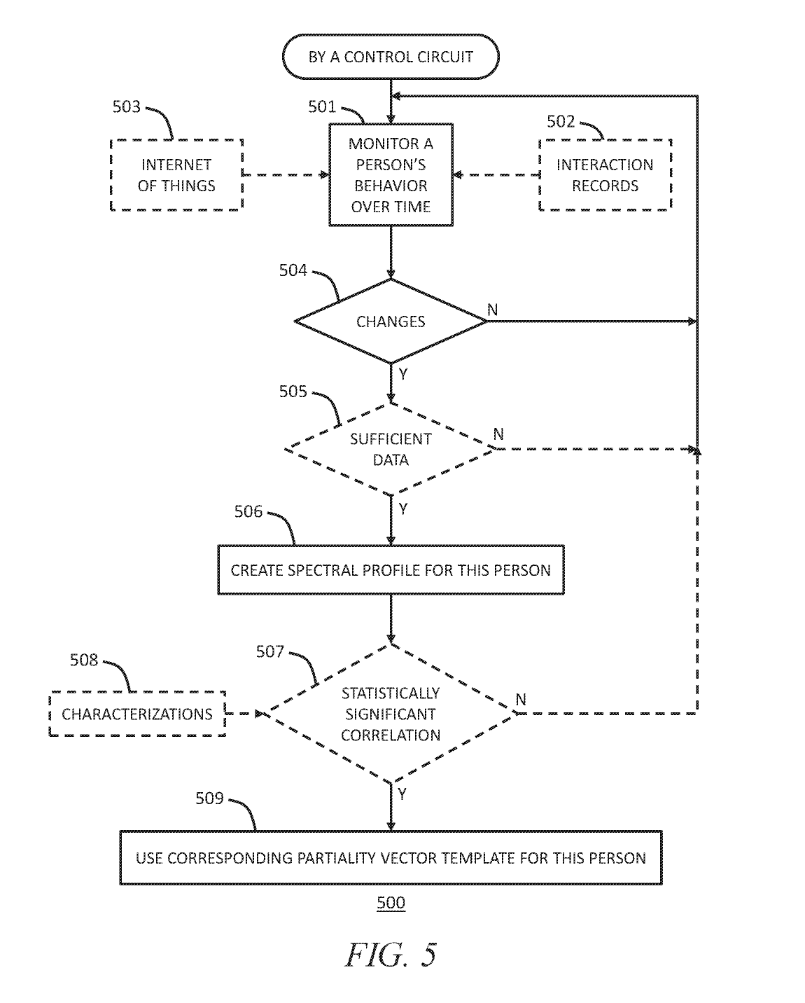

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

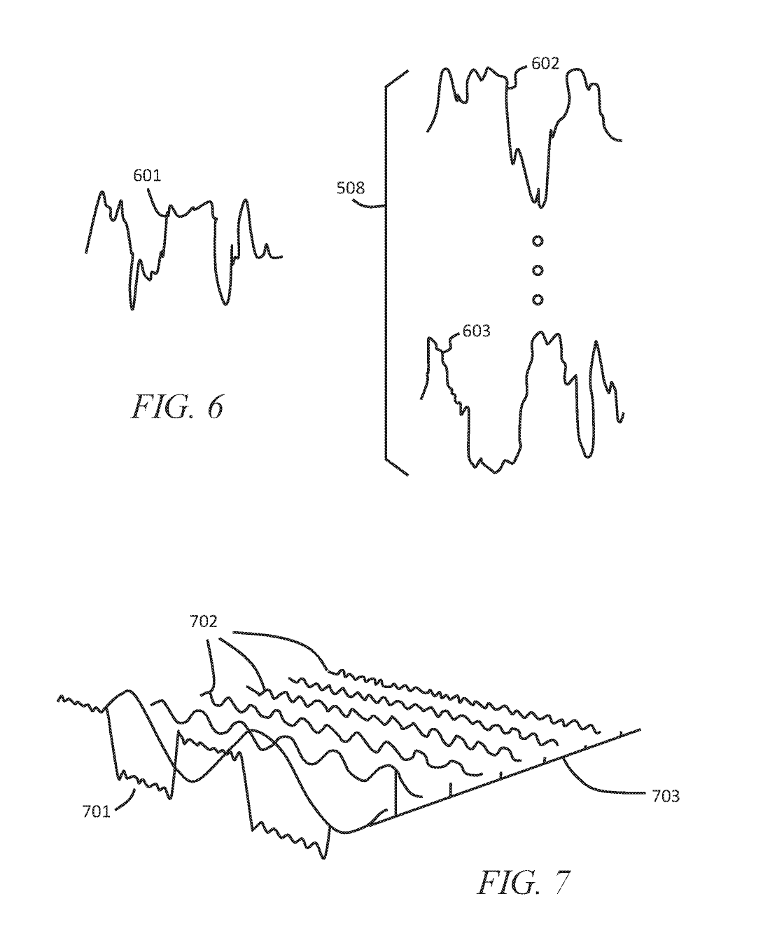

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

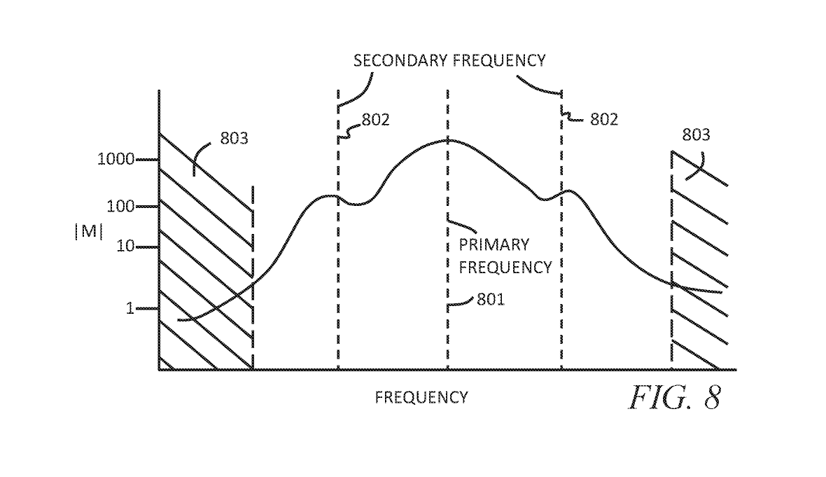

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product).

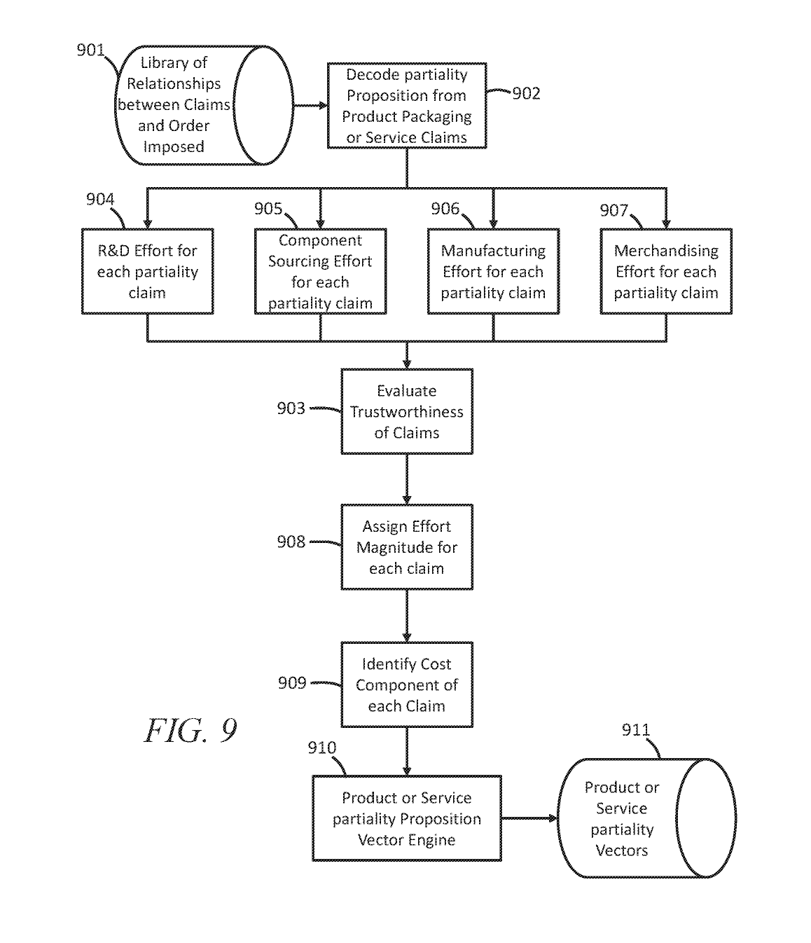

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

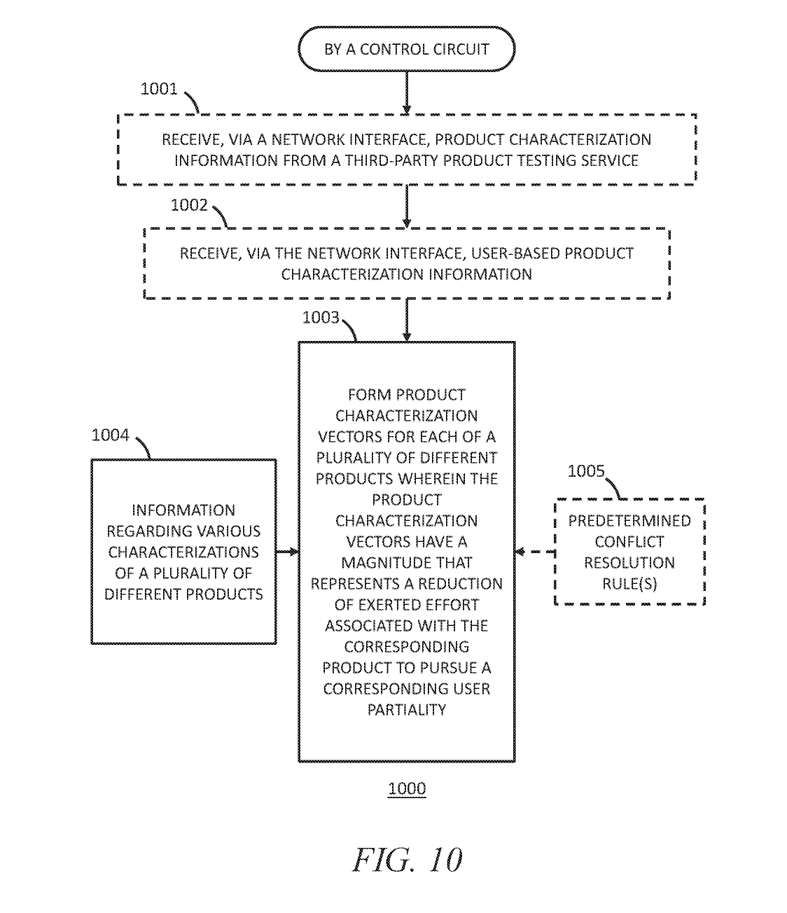

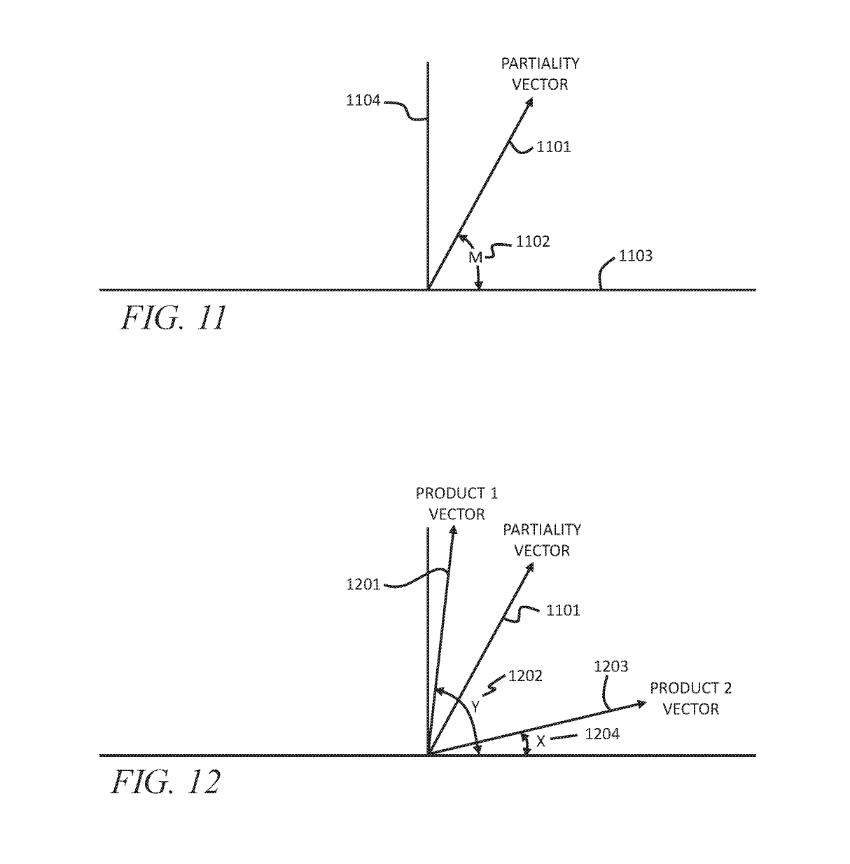

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and Ply represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½μ), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

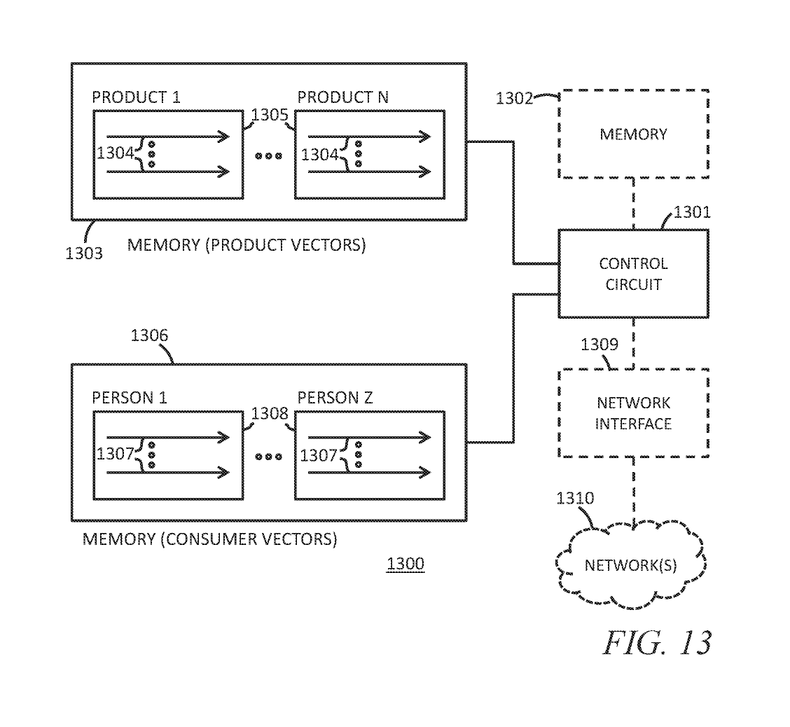

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”). It will be appreciated that the number of persons and products for whom such information is stored can be large. Storing partiality-based information in a vectorized format can greatly ease both digital storage requirements and computational resource requirements. Those skilled in the art will appreciate these improvements to the technical capabilities of both the memory and computer capabilities of such a platform.

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

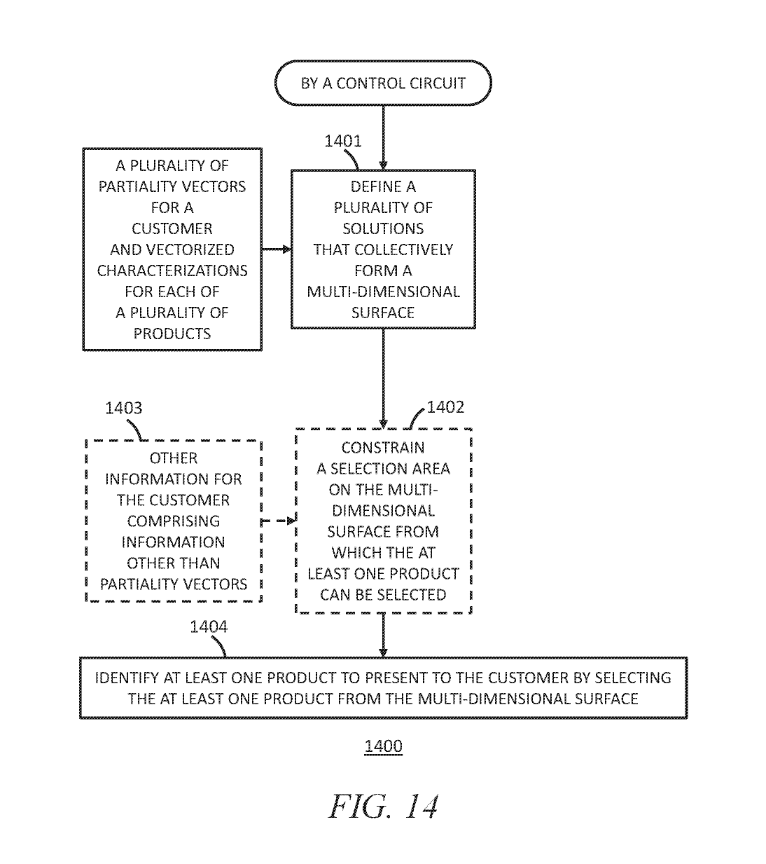

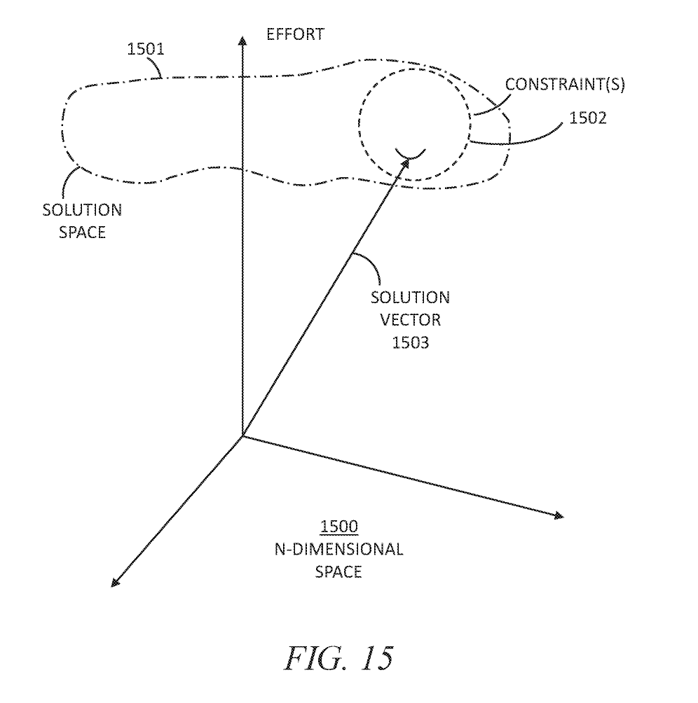

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

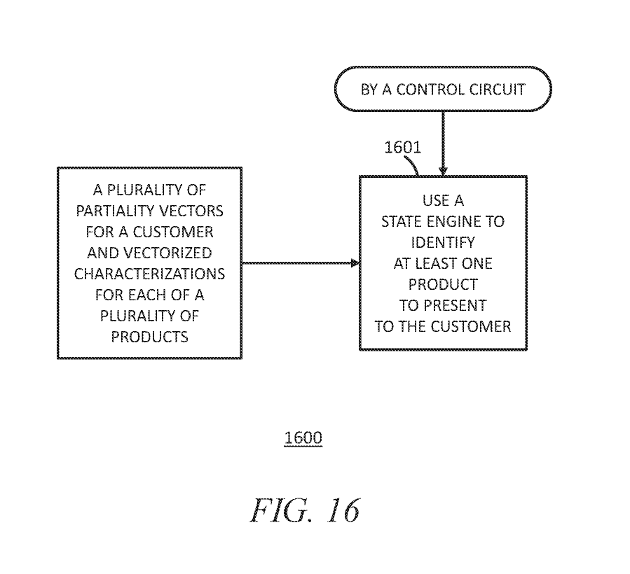

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

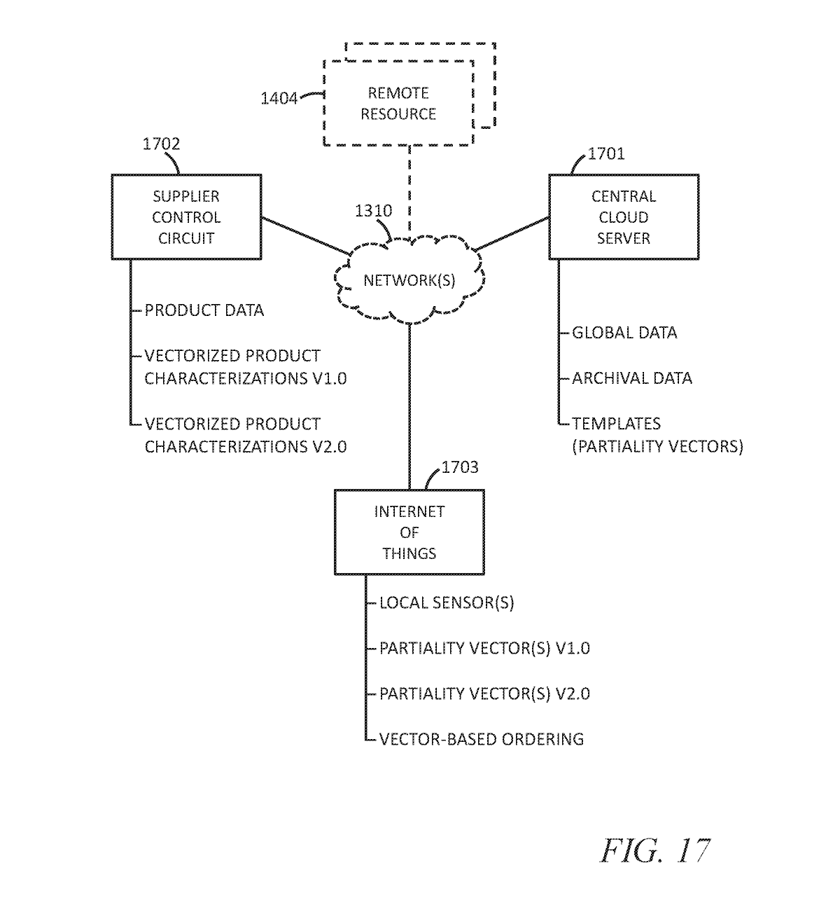

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Pursuant to various embodiments, systems, apparatuses and methods are provided herein useful for collecting customer information. In some embodiments, there is provided a system including a communication device, a customer profile database, and an item database. The communication device may communicate with a plurality of wearable devices each including one or more sensors. The customer profile database may store customer partiality vectors associated with a plurality of customers. The item database may store item characteristics (or partialities) associated with a plurality of items.

The system may also include a control circuit that may be coupled to the communication device, the customer profile database, and the item database. By one approach, the communication device may be integrated with the control circuit. The control circuit may receive, via the communication device, reaction data detected by a sensor of the one or more sensors on a wearable device of the plurality of wearable devices that is worn by a customer. The control circuit may identify one or more items associated with the reaction data. The control circuit may also identify one or more customer partiality vectors of the customer partiality vectors as being relevant to the one or more items based on item characteristics associated with the one or more items retrieved from the item database. The control circuit may update the one or more customer partiality vectors associated with the customer based on the reaction data and the item characteristic of the one or more items.

In some embodiments, there is provided a method for collecting customer information including receiving reaction data detected by a sensor of a wearable device worn by a customer. The reaction data may be received via a communication device configured to communicate with a plurality of wearable devices. The plurality of wearable devices may include sensors. The method may also include identifying one or more items associated with the reaction data. The method may further include identifying one or more customer partiality vectors as being relevant to the one or more items based on item characteristics associated with the one or more items retrieved from an item database. The identification may be executed by a control circuit that is coupled to the communication device. The method may also include updating the one or more customer partiality vectors associated with the customer stored in a customer profile database based on the reaction data and the item characteristic of the one or more items.

In yet some embodiments, there is provided an apparatus for collecting customer information including a non-transitory storage medium storing a set of computer readable instructions. The apparatus may include a control circuit configured to execute the set of computer readable instructions. The execution of the set of computer readable instructions may cause the control circuit to receive reaction data that may have been detected by a sensor of a wearable device worn by a customer. The reaction data may be received via a communication device that may communicate with a plurality of wearable devices. The plurality of wearable devices may include sensors. The communication device may be coupled to the control circuit. The control circuit may identify one or more items associated with the reaction data. The control circuit may also identify one or more customer partiality vectors as being relevant to the one or more items. The identification of the one or more customer partiality vectors may be based on item characteristics associated with the one or more items retrieved from an item database. The control circuit may update the one or more customer partiality vectors associated with the customer and stored in a customer profile database based on the reaction data and the item characteristic of the one or more items.

In some embodiments, a system is disclosed that collects customer information based on at least monitoring of customer's physiology and/or biometrics while shopping or virtual shopping. Physiology may correspond to heart rate, blood pressure, perspiration, and/or body temperature, among other examples of human physiological reactions/responses. Biometrics may correspond to fingerprints, retina, iris, facial, voice, and/or hand geometry, among other means of recognizing human's physical and/or behavioral characteristics. By one approach, as the customer shops, the system may define and maintain customer partiality vectors, which can be used by the system to identify one or more items that a customer is more likely to purchase, by monitoring the customer's physiological reactions, biometric reactions, and/or other such reaction data.

In one configuration, the physiological reactions may result from the customer seeing, touching, smelling, tasting, and/or hearing the one or more items. For example, a customer may generally like the feel of silk; therefore, when the customer touches a pair of pants that are made of silk material, the physiological reactions elicited from touching the silk material may be more intense than the physiological reactions elicited from touching a pair of pants that are made of denim or jeans material. Further, the physiological reactions may be monitored by one or more wearable devices worn by the customer. For example, the one or more wearable devices may include one or more of a heart rate sensor, a body temperature sensor, a blood oxygen level sensor, a perspiration sensor, a brain wave sensor, a step counter, other such sensors, or any combination thereof.

By one approach, the system may determine and/or track a customer's location and/or orientation within a store to identify one or more items the customer is viewing. A customer's location may be determined via video and/or image processing (e.g., facial recognition, pattern detection, etc.) of video and/or images captured by one or more cameras, detecting access of the customer's electronic device to one or more wireless network access points available through the retail shopping facility, and/or detecting an RFID tag carried by the customer (e.g., the wearable device may include the RFID tag) or on a shopping cart (e.g., customer rewards card, transmitted by the customer's electronic device, such as smartphone, tablet, computer, laptop, iPad, etc.), via wireless signal triangulation, GPS data (e.g., provided by a customer's electronic device, transmitted by a GPS system on a shopping cart), inertial sensor data, compass sensor, distance measurement data, bar code readings of bar codes throughout the shopping facility, and/or encoded light signal data, other such methods, or combination of two or more of such methods.

An illustrative non-limiting example, as the customer travels through the store, the system may initiate tracking the customer by periodically determining which wireless network access point the customer's electronic device accesses. In another illustrative non-limiting example, the system may perform facial recognition on video and/or images captured by cameras throughout the retail shopping facility. In one configuration, when the customer is recognized by the system, the system may initiate tracking of the customer for a period of time and/or until the customer leaves the shopping facility.

By one approach, the system may correlate the customer's location and/or orientation with the store's layout using one or more cameras mounted throughout the retail shopping facility, unmanned aerial vehicle deployed within the retail shopping facility, electronic device used by the customer, or any combination thereof. By another approach, the system may identify when a customer is viewing the one or more items through a virtual shopping experience. In at least one of the approaches, the system may associate timing of when the customer views the one or more items with timing of the physiological reactions to gauge the customer's interest in the one or more items. The one or more items may include consumer/commercial products, marketing materials, product placement, other such factors, or any combination thereof.

In one non-limiting illustrative example, a customer wearing a heart rate and/or pulse monitor may travel through a retail shopping facility. At a first time, the customer may stop at an ice cream shop in the retail shopping facility. Data detected, and potentially recorded and/or displayed, by the pulse monitor may indicate that the pulse of the customer reached a first pulse value as the customer looks at a first flavor of ice cream. The pulse monitor may also indicate that the customer's pulse reached a second pulse value as the customer looks at a second flavor of ice cream. In another non-limiting illustrative example, the customer may be wearing a second wearable device, for example a blood glucose monitor. Similarly, at the first time, the blood glucose monitor may detect, and potentially record and/or display, first and second glucose values as the customer looks at the first and second flavors of ice cream. The system may determine based on the first and second pulse values and/or the first and second glucose values which flavor of ice cream more closely corresponds to the customer's partiality vectors and/or which flavor the customer is more likely to purchase.

In some embodiments, the system may compare the pulse values and/or compare the glucose values to determine which of the pulse values and/or glucose values is greater. For example, the system may perform a first comparison between the first pulse value to the second pulse value and based on the first comparison determine which flavor of ice cream more closely corresponds to the customer's partiality vectors and/or which flavor the customer is more likely to purchase. In another example, the system may perform a second comparison between the first glucose value to the second glucose value and based on the second comparison determine which flavor of ice cream more closely corresponds to the customer's partiality vectors and/or which flavor the customer is more likely to purchase. In another example, the system may determine which flavor of ice cream more closely corresponds to the customer's partiality vectors and/or which flavor the customer is more likely to purchase based on multiple physiological and/or biometric readings (e.g., both the first and second above comparison examples). As such, the system may correlate results from the first and second comparisons and determine with a level of confidence which flavor of ice cream more closely corresponds to the customer's partiality vectors and/or which flavor the customer is more likely to purchase.

In some embodiment, the system may determine a difference between data detected by at least one sensor of a wearable device and a threshold value corresponding to the sensor of the wearable device. The threshold value may represent a basal or baseline physiological reaction of the customer. A customer's basal physiological reaction may be established based on physiological reaction data detected over a time period (e.g., when the customer is sleeping) by a sensor of a wearable device. By one approach, the system may average the physiological reaction data detected over time. As such, the average physiological reaction data may be identified as the baseline physiological reaction of the customer.

By another approach, the system may periodically calculate an average physiological reaction data. The system may determine whether the calculated average physiological reaction data is increasing over time. In response to an increasing average physiological reaction data, the system may notify the customer via an electronic device associated with the customer and/or the wearable device that the baseline physiological reaction associated with the customer is increasing. In one configuration, the basal physiological reaction may correspond to the customer's normal physiological data detected by the sensor (e.g., physiological reaction of the customer without environmental stimuli, such as while not viewing one or more items, evaluated sensor data while customer is viewing and/or experiencing one or more predefined stimuli, etc.).

By one approach, a customer's partiality vectors and/or identifying product that a customer is likely to purchase may be determined based on at least one of a comparison of two or more sensor data (e.g., values from the same or similar sensors), differences of one or more sensor data (or sensor values) to a threshold value, a consistent accumulation or decline of sensor data over one or more predefined periods of time, and/or other such evaluations of sensor data. In some instances, the sensor values may be representative of the data received from one or more sensors of one or more wearable devices.

In an illustrative non-limiting example, a first sensor of a customer's wearable device may detect increased heart rate during a time that the customer is at a coat area of the retail shopping facility. At the time, a second sensor of the customer's wearable device may also detect increased body temperature. In response to a comparison of each detected sensor data (e.g., heart rate and body temperature) to a particular threshold value, the system may determine that the customer is experiencing a very strong reaction towards something in the coat area based on the sensor data reaching the particular threshold value. In one configuration, the system may determine what the customer is looking at the time based on the captured video images of the cameras located within the coat area. As such, the system may perform image detection to the captured video images and, for example, subsequently determine that the customer may be looking at a mink coat. Based on the very strong reaction detected from the customer, the system may determine that the customer has a high affinity towards animals. In another configuration, the system may store data associated with the customer's affinity for animals in a customer profile database.

In some embodiments, data associated with the physiological reactions may be gathered and/or stored over a period of time to define magnitude and directional representations of one or more customers' partiality vectors (see paragraphs below for detailed descriptions of partiality vectors). The data and sets of partiality vectors may be used to create marketing information or modify existing marketing information directed to the customer. The marketing information may be sent to at least one of a smartphone, a laptop, a tablet, a smartwatch, a display device that is worn, to a display device that is in close proximity to and/or a distance and/or orientation relative to the customer, provided to the customer through other methods, or a combination of two or more of such methods. Further, in some embodiments, the customer profile database of the system may include value proposition vectors of a plurality of customers. The customer profile database may track physiological reactions of the plurality of customers to products, marketing, product placement, and the like. By one approach, one or more sensors may be placed in a retail shopping facility to track the customers' physiology and/or biometrics. Additionally or alternatively, one or more sensors carried and/or worn by the customer may track physiology and/or biometrics and communicate physiology and/or biometrics data to the system.

The physiology and/or biometric data may indicate heart rate, blood pressure, blood oxygen levels, blood sugar levels, body temperature, perspiration levels, and the like. Changes in physiology and/or biometrics may be used to determine a customer's emotional responses that correspond to the customer's partiality vectors. In another configuration, sensor data may further determine a customer's dimensions and recommend relevant sizes of cloths. For example, 3D body measurements may be captured and the system may use the captured 3D body measurements to recommend products based upon body characteristic.

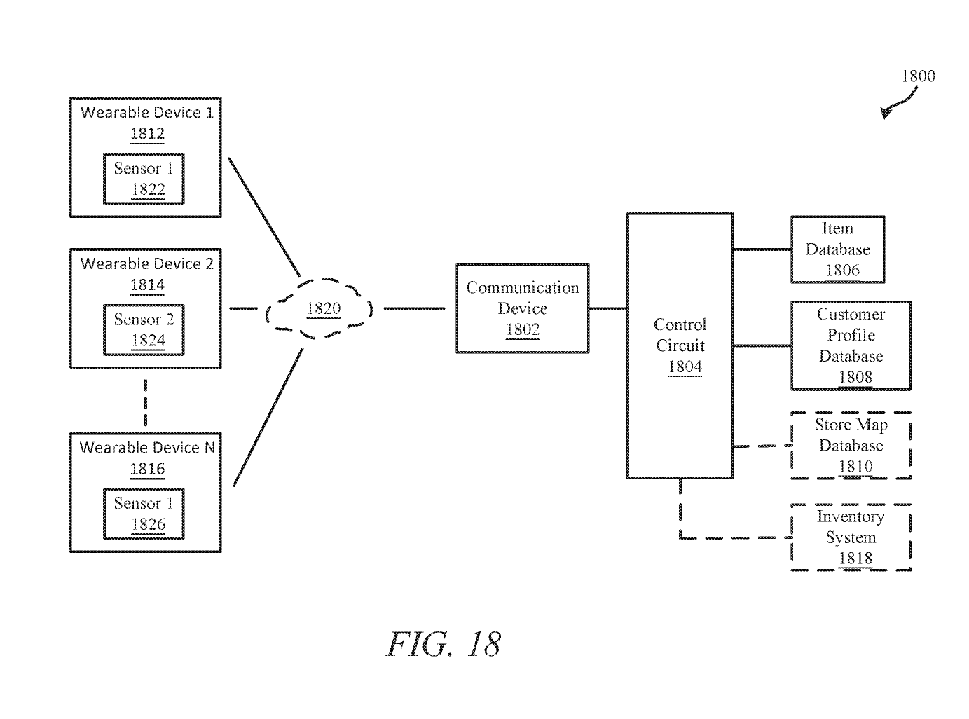

FIG. 18 illustrates an exemplary system 1800 for collecting customer information. The system 1800 includes a communication device 1802 that may communicate with a plurality of wearable devices 1812, 1814, 1816, a customer profile database 1808 that store customer partiality vectors associated with a plurality of customers, and an item database 1806 that may store item characteristics associated with a plurality of items. As described herein, an item may correspond to a product. A retail shopping facility sell numerous different types of products. As one simple example, a retail shopping facility may sell two different types of corn flakes cereal products (e.g., Great Value Corn Flakes Cereal and Kellogg's Corn Flakes). An item corresponds to one of a specific product (e.g., an item may be a 20 oz. box of Great Value Corn Flakes, a different item may be a 28 oz. box of Great Value Corn Flakes, a different item may be a 16 oz. box of Kellogg's Corn Flakes, a different item may be a 12 pack of 12 oz. cans of Coca-Cola, etc.). A customer may buy any number of items of one or more products. For example, a customer may buy two items of the same cereal product or one item of each of two different cereal products (e.g., 20 oz. Great Value Corn Flakes Cereal and 16 oz. Kellogg's Corn Flakes). As a further example, the customer may buy two 16 oz. boxes of Kellogg's Corn Flakes and one 20 oz. box of Great Value Corn Flakes Cereal. Thus, a plurality of items may be associated with multiple different products or a single product. By one approach, the communication device 1802 may include a router, a transceiver, a Bluetooth device, or a network gateway device, among other devices configured to couple to a wired and/or wireless network. By another approach, the communication device 1802 may be included in a control circuit 1804. The plurality of wearable devices 1812, 1814, 1816 may each include one or more sensors 1822, 1824, 1826. The one or more sensors 1822, 1824, 1826 may include, but are not limited to, at least one of a heart rate sensor, a body temperature sensor, a blood oxygen level sensor, a moisture and/or perspiration sensor, a brain wave sensor, a step counter, a distance measurement sensor, other such sensors or sensor systems, or a combination of two or more of such sensors. In some embodiments, other sensors may additionally or alternatively be utilized. Such other sensors may include, but are not limited to, a distance measurement sensor, an RFID tag reader, an encoded light signal detector, an optical code reader, a camera, other such sensors, or combination of two or more other sensor, or combination of two or more other sensors.

In one configuration, the system 1800 may include the control circuit 1804 that may be coupled to the communication device 1802, the customer profile database 1808, and the item database 1806. The control circuit 1804 may receive, via the communication device 1802, reaction data detected by a sensor of the one or more sensors 1822, 1824, 1826 of the wearable device(s) 1812, 1814, 1816. By one approach, the control circuit 1804 may include the communication device 1802. Again, the system may utilize plurality of wearable devices 1812, 1814, 1816 that can be worn by a customer at least while the customer travels through the retail shopping facility. The reaction data may include data generated by the wearable device based on one or more physiological reactions, biometrics reactions, and/or other such reaction data detected from the customer.

By one approach, the wearable device(s) 1812, 1814, 1816 may process sensor data detected by the sensor(s) 1822, 1824, 1826 to data readable by the control circuit 1804. By another approach, the wearable device(s) 1812, 1814, 1816 may store the sensor data and send the reaction data which includes the sensor data to the control circuit 1804. In one configuration, the control circuit 1804 may identify one or more items associated with the reaction data based on the customer's location and orientation. For example, one or more cameras in the retail shopping facility are accessed by the control circuit 1804 and/or video and/or image data captured by one or more cameras and stored in an image database may be accessed by the control circuit to determine at which item(s) the customer is looking, considering and/or focusing that caused the physiological reactions and/or biometrics reactions detected by the sensor(s) 1822, 1824, 1826. Additionally or alternatively, the control circuit 1804 may determine the customer's location and/or orientation based at least in part on wireless access point accessed by an electronic device associated with the customer.

In some embodiments, the control circuit 1804 may identify a set of one or more items and/or item information that the customer may be considering. This information may be limited to a single item of a product (e.g., when the customer is at an endcap of an aisle and only a single item is present), while in other instances the customer may potentially be considering one or more items from multiple different products. Further evaluation of other information, such as but not limited to historic purchases, customer partiality vectors relative to product partiality vectors, recent on-line inquires, access to a shopping list, related products already acquired and in the customer's shopping cart, and/or other such information, may be considered in identifying one or more items from multiple products that the customer is more likely considering.

For example, the control circuit 1804 may determine from records of the customer's previous purchases that the customer often purchases cereal every two weeks, and that it has been two weeks since the last cereal purchase of the customer. As such, for example, the control circuit 1804 may determine that the customer may be looking at a cereal item based on the records of the customer's previous purchases, wireless access point accessed by the electronic device associated with the customer, and/or camera(s) associated with an area covered by the wireless access point accessed by the electronic device associated with the customer.

In some embodiments, the control circuit 1804 may determine whether the reaction data corresponds to a positive or a negative reaction based on a comparison of the reaction data with one or more threshold values. For example, the control circuit 1804 may be configured to determine that the reaction is a positive reaction when the reaction data reaches the threshold value. In another example, the reaction may be determined to be negative when the reaction data is less than the threshold value. In one configuration, the positive reaction may correspond to a customer exhibiting a behavior corresponding to a favorable opinion of a particular item, such as having a smiley facial expression, among other similar facial expressions. For example, while a customer is exhibiting a smiley facial expression when looking at a particular item, one or more of the sensors 1822, 1824, 1826 of the wearable device(s) 1812, 1814, 1816 associated with the customer may detect that the customer's blood pressure is at or a closer number below or above the customer's blood pressure baseline. Thus, the customer's physiological reaction and biometric reaction corresponds to the customer having a favorable opinion of the particular item.

On the other hand, the negative reaction may correspond to the customer exhibiting a behavior corresponding to an unfavorable opinion of the particular item. For example, the customer may exhibit a sad or disgusted facial expression when looking at the particular item while the one or more of the sensors 1822, 1824, 1826 may detect that the customer's blood pressure has reached a threshold value. Thus, the customer's physiological reaction and biometric reaction corresponds to the customer having an unfavorable opinion of the particular item. In some embodiments, the control circuit 1804 may update one or more of the customer partiality vectors associated with the customer based on whether the reaction data corresponds to a positive or a negative reaction. For example, an update may occur to a corresponding customer partiality vector each time a determination of positive or negative reaction is made by the control circuit 1804.

In some embodiments, the one or more items are identified based on one or more of a location sensor, a Radio Frequency Identification (RFID) sensor, a near field communication (NFC) sensor, an optical sensor, a camera, and short-range data transceiver on the wearable device(s) 1812, 1814, 1816. The wearable device(s) 1812, 1814, 1816 and/or the sensors 1822, 1824, 1826 of the wearable device(s) 1812, 1814, 1816 may communicate via a wireless communication and/or computer network 1820 (e.g., Wi-Fi, cellular, Bluetooth, Bluetooth Lite, etc.). In some implementations, one or more of the sensors 1822, 1824, 1826 and/or wearable device(s) 1812, 1814, 1816 may communicate with a customer's smartphone or other such portable device that communicates via the network 1820 with the control circuit 1804 and/or one or more databases 1806, 1808, 1810.

In some embodiments, one or more items are identified based on a particular location and/or orientation of the wearable device(s) 1812, 1814, 1816 within an area of the retail shopping facility (or a shopping space) and a store map database 1810 that stores item and/or item advertisement locations in the area. For example, the control circuit 1804 may identify the one or more items within a threshold distance by correlating the particular location and/or orientation of the wearable device, an electronic device associated with the customer, and/or the customer with the store map database 1810 and an inventory system 1818. In one configuration, the inventory system 1818 may include location information of the one or more items. In an illustrative non-limiting example, location and/or orientation of the customer in the retail shopping facility may be determined based on determining which wireless access point is accessed by the electronic device associated with the customer. In response to determining the wireless access point accessed by the electronic device, the control circuit 1804 may access the store map database 1810 and/or the inventory system 1818 to determine or estimate based on the location and/or orientation of the customer which item(s) the customer may be looking, focusing, or considering at the time the reaction data is detected by the sensor(s) 1822, 1824, 1826 and/or received by the control circuit 1804.

Some embodiments use the location of the customer to identify, based on the inventory mapping in the inventory system 1818, one or more items that are within a threshold distance from the customer. In a non-limiting illustrative example, the system may limit the number of items considered based on a threshold angle of viewing relative to the orientation of the customer. Further, the system may consider correlations between the customer and product partiality vectors and/or other information (e.g., historic purchases, shopping lists, other products in the customer's cart, etc.).

In some embodiments, the control circuit 1804 may identify one or more customer partiality vectors of the customer partiality vectors as being relevant to the one or more items based on item characteristics associated with the one or more items retrieved from the item database. Being relevant may correspond to one or more customer partiality vectors and one or more product partiality vectors being directionally aligned. In an illustrative non-limiting example, a customer partiality vector that may be associated with a customer is the customer's affinity for animals. For example, a manufacturer of a make-up product may be associated with one or more characteristics that are associated with a make-up item. In one instance, the manufacturer may be known for not using animals to test its products. The “no animal testing” policy may correspond to a product partiality vector. As such, one product partiality vector that may be associated with the make-up item is the manufacturer's “no animal testing” policy. Thus, the customer's affinity for animals is directionally aligned with the “no animal testing” policy of the manufacturer of the make-up item. Therefore, in this illustrative non-limiting example, the control circuit 1804 may identify the customer's affinity for animals as being relevant to the make-up item based on the “no animal testing” (e.g., a characteristic) policy of the manufacturer of the make-up item. Further, a product identifier associated with the make-up item may be stored in the item database 1806. Some embodiments may evaluate an alignment value determined by performing a dot product between a customer partiality vector and a corresponding product partiality vector.

Moreover, the partiality vectors described herein may include, in context, a value-based, an affinity-based, an aspiration-based, and/or a preference-based partiality. For example, customer partiality vectors may include at least one of a value-based, a preference-based, an affinity-based, and an aspiration-based partiality of a person or a customer. In another example, each of the customer partiality vectors may have a magnitude that corresponds to a determined magnitude of a strength of a belief by respective customer in an amount of good that comes from an amount of order imposed upon material space time by a corresponding particular partiality.

By one approach, the control circuit 1804 may update the one or more customer partiality vectors associated with the customer based on the reaction data and the item characteristic of the one or more items. The update may include associating the one or more items with the customer in the customer profile database 1808. The update may further include associating the one or more items to the one or more customer partiality vectors of the customer. In another configuration, the customer partiality vectors may be determined based on reaction data associated with a plurality items aggregated over time. Some embodiments may update customer partiality vectors based on corresponding product partiality vectors associated with the one or more items, and/or an alignment or lack of alignment between customer partiality vectors and product partiality vectors.

To illustrate, referring to the illustrative non-limiting example regarding a customer experiencing a very strong reaction towards the mink coat in the coat area, the control circuit 1804 may update the partiality vectors associated with the customer's affinity for animals in response to the increased heart rate and body temperature detected by the sensor(s) 1822, 1824, 1826 of the wearable device(s) 1812, 1814, 1816 worn by the customer. By one approach, the control circuit 1804 may also update data associated with the customer in the customer profile database 1808 by storing an item identifier associated with the item in the customer data of the customer profile database 1808. The item may correspond to the item the customer is looking at, focusing on, or considering at the time the customer's heartrate and body temperature increased.

For example, the control circuit 1804 may determine that the mink coat is the item that caused the customer's increased heartrate and body temperature. In response, the control circuit 1804 may store an identifier associated with the mink coat in the data associated with the customer in the customer profile database 1808. By one approach, the control circuit 1804 may relate in the customer profile database 1808 the item identifier associated with the mink coat with the customer's partiality vector associated with the customer's affinity for animals. By another approach, the control circuit 1804 may update a magnitude and/or direction associated with the customer's affinity for animals based on a difference or a degree of difference between the sensor data and a particular threshold value. For example, a sensor data that is a value higher than the particular threshold value may indicate that the magnitude associated with the customer's affinity for animals corresponds to a strong belief or affinity for animals. In one configuration, the particular threshold value may correspond to a baseline measurement described herein.

In another illustrative non-limiting example, the one or more items may be associated with products manufactured by one or more companies that are known for being environmentally friendly. The one or more items may be associated with one of a plurality of product partiality vectors, such as environmentally friendly, animal friendly, made in U.S.A., among other value-based, affinity-based, and/or aspiration-based partialities or characteristics, stored in the item database 1806. By one approach, the control circuit 1804 may determine that the one or more customer partiality vectors are associated with the customer that produced the one or more physiological reactions. The control circuit 1804 may then update the one or more customer partiality vectors indicating that the customer may have affinity for products that were manufactured by environmentally conscious company.

Moreover, the control circuit 1804 may establish a baseline measurement associated with the customer (or a baseline customer measurement) based on monitoring data from one or more sensor(s) 1822, 1824, 1826 of one or more wearable device(s) 1812, 1814, 1816 over time. In one example, the baseline measurement may correspond to basal physiological reaction of the customer. The basal physiological reaction may be the physiological data detected by the sensor(s) 1822, 1824, 1826 when the customer is asleep and/or exposed to a predefined set of one or more stimuli, among other means of establishing a baseline. The predefined set of one or more stimuli may be associated with a customer taking a predefined survey, and/or a customer-selected stimuli, among other means of establishing predefined set of stimuli.

For example, at an initial learning phase of the wearable device(s) 1812, 1814, 1816, the control circuit 1804 may prompt, via the wearable device(s) 1812, 1814, 1816, the customer to select one or more stimuli and/or a time to initiate learning the customer's basal physiological reaction. By one approach, the customer may identify to the control circuit 1804 the activity the customer is undertaking at the time the control circuit 1804 is learning the customer's basal physiological reaction. By another approach, the customer may provide to the control circuit 1804 a schedule to learn the customer's basal physiological reaction. In one configuration, the control circuit 1804 may store the customer's basal physiological reaction in the customer profile database 1808. In another configuration, baseline measurements taken over time may be stored in the customer profile database 1808 as a representative range of values that may be used as threshold values to be compared with reaction data received from the sensor(s) 1822, 1824, 1826 of the wearable device(s) 1812, 1814, 1816.

By one approach, the control circuit 1804 may detect a reaction event based on comparing sensor data with the baseline measurement prior to using the sensor data as the reaction data. A reaction event may be detected when the sensor data is a threshold difference from the baseline measurement or has reached the baseline measurement. A sensor associated with one of the plurality of wearable devices 1812, 1814, 1816 may generate the sensor data. By another approach, one or more customer partiality vectors of the customer partiality vectors associated with the customer may be updated based one or more differences or a degree of difference between the reaction data and the baseline measurement. For example, one or more magnitudes associated with one or more customer partiality vectors may be updated based on the one or more differences or the degree of difference between the reaction data and the baseline measurement.

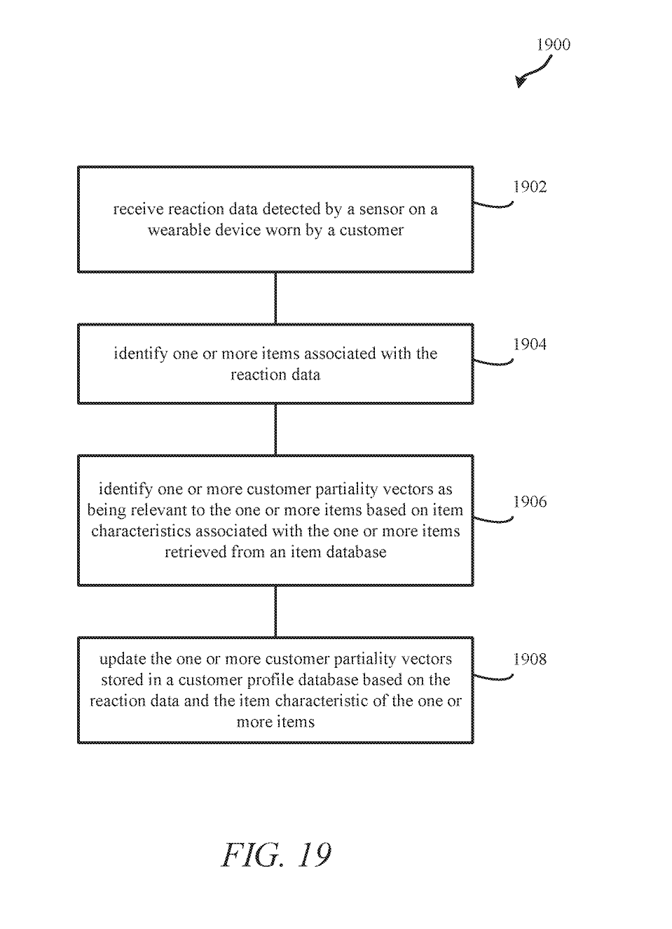

FIG. 19 illustrates a flow diagram of an exemplary method 1900 for collecting customer information. The exemplary method 1900 may be implemented in the system 1800 of FIG. 18. The method 1900 includes, at step 1902, receiving reaction data detected by a sensor of a wearable device worn by a customer. For example, the communication device 1802 of FIG. 18 may receive the reaction data from a sensor of one of the plurality of wearable devices 1812, 1814, 1816 worn by the customer. At step 1904, identifying one or more items associated with the reaction data. At step 1906, the method 1900 may also include identifying one or more customer partiality vectors as being relevant to the one or more items based on item characteristics associated with the one or more items retrieved from an item database. The item database may correspond to the item database 1806 of FIG. 18. By one approach, the identifications of the one or more items and the identifications of the one or more customer partiality vectors may be executed at the control circuit 1804 of FIG. 18. At step 1908, the method 1900 may also include updating the one or more customer partiality vectors associated with the customer stored in a customer profile database based on the reaction data and the item characteristic of the one or more items. By another approach, the customer profile database may correspond to the customer profile database 1808 of FIG. 18.

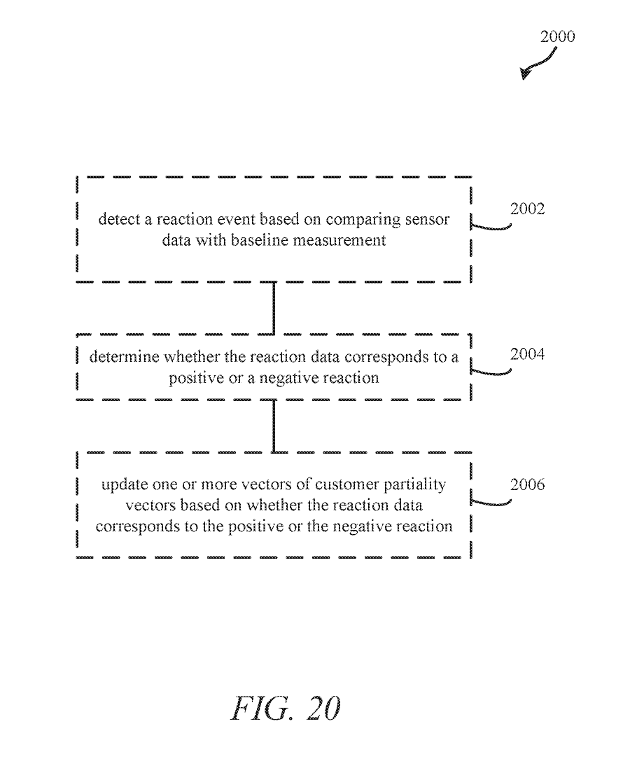

FIG. 20 illustrates a flow diagram of an exemplary method 2000 for collecting customer information. The exemplary method 2000 may be implemented in the system 1800 of FIG. 18. By one approach, the method 1900 of FIG. 19 may include one or more steps of the method 2000. The method 2000 includes, at step 2002, detecting a reaction event based on comparing sensor data with a baseline measurement. By one approach, the comparison may be performed prior to using the sensor data as reaction data. At step 2004, the method 2000 may include determining whether the reaction data corresponds to a positive or a negative reaction. The method 2000 may also include updating one or more vectors of customer partiality vectors associated with a customer based on whether the reaction data corresponds to the positive or the negative reaction, at step 2006.

Pursuant to various embodiments, systems, apparatuses and methods a control circuit may be implementing having access to this memory is configured to select a particular person from the aforementioned persons and then identify a set of the partiality vectors that are known to apply to this selected consumer to provide a base set of partiality vectors. The control circuit then uses a rule-based approach to filter the aforementioned information to identify a plurality of other persons who share that base set of partiality vectors and who also have at least one other partiality vector. The control circuit can then use a further rule-based approach to identify, as a function of the at least one other partiality vector, at least one candidate partiality vector that may be applicable to the selected consumer.

By one approach the control circuit selects the aforementioned particular individual person as a function, at least in part, of any of a variety of preferred criteria and/or other data points/parameters of interest. Examples include but are not limited to user-entered consumer-selection criterion, a predetermined geographic area, a predetermined demographic data value, a requirement that the selected person have at least a predetermined number of partiality vectors associated therewith, a predetermined vocational status, a predetermined religious belief system, and/or a predetermined political affiliation, to note but a few.

By one approach the control circuit identifies the aforementioned base set of partiality vectors by, at least in part, requiring that the partiality vectors associated with the selected person include at least one predetermined partiality vector. This predetermined partiality vector may be determined automatically and/or by one or more authorized persons.

The aforementioned filter rules can include a rule requiring, for example, that each identified person not only share the base set of the partiality vectors but also have at least some predetermined number of other partiality vectors. The aforementioned identification rules, in turn, can include a rule requiring, for example, that at least a certain number (such as a majority) of the plurality of selected persons who share the base set of partiality vectors also share the at least one candidate partiality vectors.

These teachings are highly flexible in practice and will accommodate various supplemental features and/or modifications. As one example in these regards, the aforementioned filter rules can include an exclusionary rule requiring that the selected persons not have one or more particularly identified partiality vectors in addition to sharing the base set of the partiality vectors and having at least one other partiality vector that is not specifically precluded.

So configured, the aforementioned candidate partiality vector can provide useful insight into identifying additional partialities for the originally selected person. Candidate partiality vectors can then be used, for example, to help filter and present products and services more likely to meet the full spectrum of partialities for such persons. To the extent that the person's purchasing and/or return behaviors then accord with the candidate partiality vector, that particular partiality vector can be added to the list of known partiality vectors for that particular person.

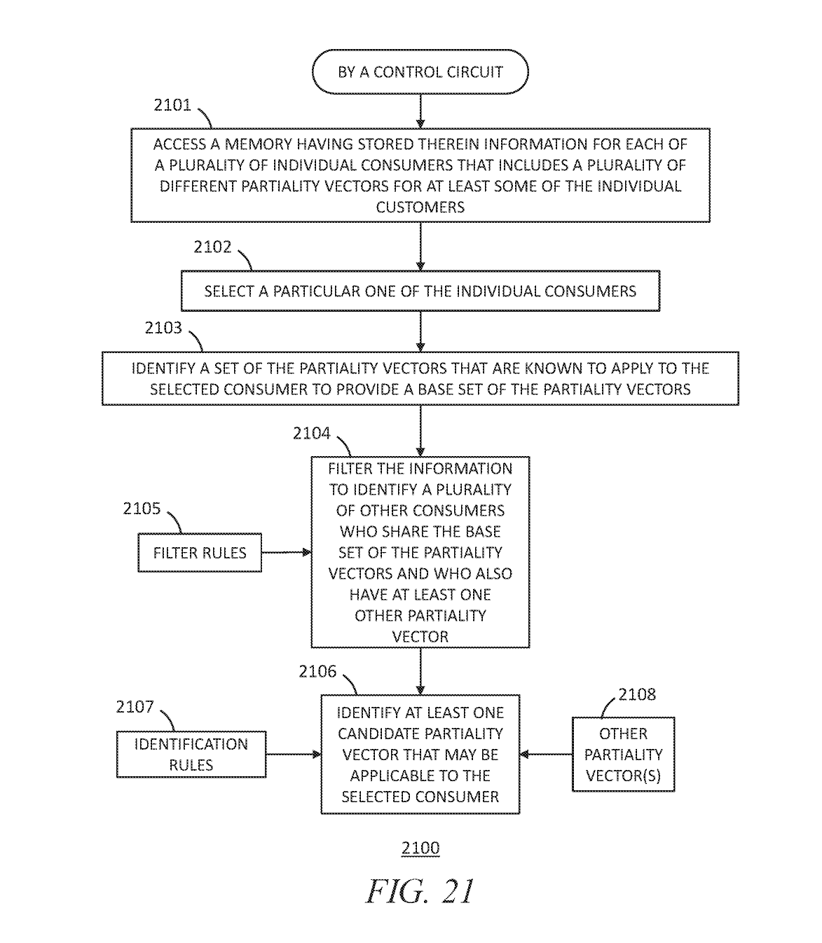

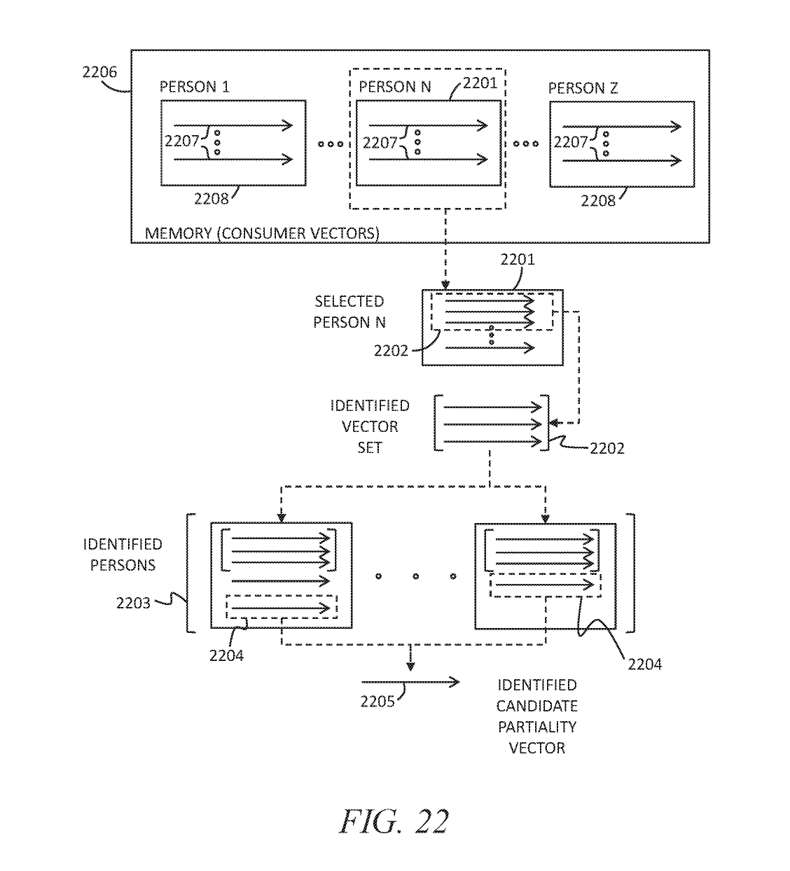

With the foregoing in mind, and referring now to FIGS. 21 and 22, a rule-based approach for identifying possible consumer partialities will now be described. More particularly, a process 2104 that employs the aforementioned apparatus 1300 as a rules-based apparatus to identify a possible consumer partiality is described.

At block 2101 of FIG. 21, the aforementioned control circuit 1301 accesses a memory 1306 having stored therein, for each of a plurality of individual consumers 1308, information that includes a plurality of different partiality vectors 1307 for at least some of those individual consumers 1308. In this illustrative example there are Z such persons 1308, where Z is an integer greater than 1. In a typical application setting Z will likely be a relatively large number having 6, 7, or 8 figures or even a higher number of figures.

At block 2101 the control circuit 1301 selects a particular one of those individual consumers 1308. In this illustrative example this selected consumer is identified by reference numeral 2201 and is denoted “Person N” in FIG. 22. For the purposes of this description this person 2201 is largely referred to herein as the “selected consumer” or the “selected person.”

These teachings will accommodate various approaches for selecting the selected consumer 2201. As one simple example the selected consumer 2201 can be selected randomly and/or in some iterative, consecutive manner where each consumer is eventually selected. Depending upon the needs of a given application setting, however, there are various other factors or considerations upon which this selection can be based. As one example in these regards, this selection can be made as a function, at least in part, of a user-entered consumer-selection criterion. This “user” can be, for example, an administrator or other authorized person using the aforementioned apparatus 1300.

As another example, this selection can be made as a function, at least in part, of a predetermined geographic area. For example, this process 2100 may be focusing on consumers living in a particular state, municipality, neighborhood, or within a particular distance of, for example, a particular retail shopping facility.

As another example, this selection can be made as a function, at least in part, of a predetermined demographic data value. For example, this process 2100 may be focusing on consumers belonging to a particular gender, age group, nationality or citizenship, or the like.

As another example, this selection can be made as a function, at least in part, of a requirement that the selected consumer 2201 have at least a predetermined number of partiality vectors 1307 associated therewith. For example, it may be appropriate to require that the selected consumer 2200 have at least three partiality vectors 1307 associated therewith. In these same regards, it may be appropriate to require that the predetermined number of partiality vectors 1307 all pertain to a particular category of partiality, such as value-based partialities or aspiration-based partialities.

As another example, this selection can be made as a function, at least in part, of a predetermined vocational status. For example, this process 2100 may be focusing on consumers who are employed (or, conversely, not employed) in a particular vocation.

As another example, this selection can be made as a function, at least in part, of a predetermined religious belief system. For example, this process 2100 may be focusing on consumers having or practicing a particular religion (which may, for example, be relevant to whether the person observes particular holidays or other events or particular dietary restrictions having significance to that religion).

And as yet another example, this selection can be made as a function, at least in part, of a predetermined political affiliation. For example, this process 2100 may be focusing on consumers having (or, conversely, not having) a particular political affiliation as reflected or measured, for example, by affiliation with a particular political party or a particular affinity group having a corresponding political sensibility that tends to be associated with such things as valuing personal freedom, gun rights, conservative or liberal agendas, social or personal responsibilities, and so forth

At block 2103, the control circuit 1301 identifies a set of partiality vectors that are known to apply to the selected consumer 2201 to thereby provide a base set 2202 of the partiality vectors. These teachings will accommodate various approaches in these regards. Generally speaking, it will likely be more typical than not that the base set 2202 of the partiality vectors will constitute a smaller subset of all of the partiality vectors 1307 for the selected person 2201.

By one approach, it may be a requirement that the base set 2202 include at least one predetermined partiality vector; i.e., a particular specific partiality vector that the process 2100 requires be included prior to the moment of need described here. Or, if desired, it may be a requirement that the base set 2202 include at least two predetermined partiality vectors. Or, as yet another possibility, it may be a requirement that the base set 2202 include at least three predetermined partiality vectors. Depending upon the needs of the application setting, it may be a requirement that an even larger number of different partiality vectors comprise the base set 2202. As a simple example in these regards, it may be required that the base set 2202 include at least three predetermined partiality vectors such as a first partiality vector for frugality, a second partiality vector for environmental sensibilities, and a third partiality vector for cleanliness.

At block 2104 the control circuit 1301 employs filter rules 2105 to filter the aforementioned information in the memory 1306 to identify a plurality of other consumers (referred to in FIG. 22 as “identified persons” 2203) who share the aforementioned base set 2202 of partiality vectors and who also have at least one other partiality vector 2204. The aforementioned filter rules 2105 can comprise, for example, a requirement that the identified persons 2203 share not only the aforementioned base set 2202 but who also have at least some greater number of other partiality vectors such as two additional partiality vectors, three additional partiality vectors, five additional partiality vectors, ten additional partiality vectors, or some other numerical requirements of choice.

As another example, in lieu of the foregoing or in combination therewith, the aforementioned filter rules 2105 can comprise a requirement that the identified person not have one or more particularly identified partiality vectors associated with them. Such a requirement can be helpful, for example, when particular partialities are empirically or theoretically understood to carry considerable influential weight that may be, in context, inappropriate for the selected consumer 2201.

The number of persons included in the group of identified persons 2203 will of course vary with any number of factors, including the initial number of persons 1308 in the original pool of persons, the inherent exclusiveness imposed by the filter rules 2105, and so forth. Accordingly, if desired, this process 2100 can include a requirement that the identified persons 2203 include at least a predetermined number of persons. When this condition is not met, the process 2100 can automatically terminate this particular activity and revert to some predetermined alternatives. Examples in the latter regard include but are not limited to halting the entire process, restarting the process to select a new particular consumer, automatically altering one or more of the filter rules 2105 or other conditions of the process 2100, alerting an authorized user regarding this processing state, and so forth as desired.

At block 2106 the control circuit 1301 uses identification rules 2107 to identify, as a function, at least in part, of the aforementioned selected other partiality vector(s) 2204 (also denoted in FIG. 21 by reference numeral 2108) at least one candidate partiality vector 2205. The identification rules 2107 may include, for example, a rule requiring that at least a certain number of the identified persons 2203 also share the at least one candidate partiality vector 2205. As a simple example in these regards, such a rule may require that at least a majority of the identified persons 2203 also share this particular partiality vector 2205. The identification rules 2107 may also include, in lieu of the foregoing or in combination therewith, a rule requiring that identified persons 2203 having the candidate partiality vector 2205 not also have one or more predetermined partiality vectors of concern.

This identified candidate partiality vector 2205 (or vectors, when such is the result of the foregoing process 2104) may be applicable to the selected consumer 2201. That is, as a statistical point of interest, since many other consumers who share the base set 2202 of partiality vectors 1307 with the selected person 2201 also share the identified candidate partiality vector 2205 amongst themselves, there is an increased likelihood that the identified candidate partiality vector 2205 also applies, to a greater or lesser extent, to the selected consumer 2201.

There are various ways to apply and leverage the aforementioned result. By one simple approach the identified consumer 2201 can be contacted and presented with a survey or questionnaire that specifically directly tests this person's partialities in these regards. By another approach, the identified candidate partiality vector 2205 can be at least temporarily, on a test basis, included in the list of partiality vectors for this particular person when considering products and/or services to present, one way or the other, to this person going forward. As the person's reaction to proffered products/services reflect whether the identified candidate partiality vector 2205 in fact applies, the “candidate” status of the partiality vector can be modified accordingly and/or the magnitude of this partiality vector can be reduced or increased accordingly.

Pursuant to various embodiments, systems, apparatuses and methods are provided herein useful to provide retail customers with information about products and/or supply products to the customers that are expected to change the customers' purchase patterns. Some embodiments provide a distributed retail partiality vector system comprising: a distributed and decentralized customer subjective database storing, for each of multiple different customers, a set of multiple subjective customer data corresponding to subjective characteristics associated with product purchase decisions by the respective customer; and a distributed and decentralized processing system communicatively coupled with a separate central processing system. Further, in some implementations the decentralized processing system includes a different remote processing system associated with each of the multiple customers, and corresponding local subjective databases each coupled with a respective one of the remote processing systems and storing a corresponding set of the sets of subject customer data of the decentralized customer subjective database corresponding to one of the multiple customers. Each of the remote processing systems are additionally configured to: receive at least one objective data from the central processing system communicatively coupled with a central objective database storing objective data corresponding to: a plurality of different products offered for sale through a corresponding retail facility, and multiple customers and at least the multiple customers' activities associated with product purchasing; evaluate the at least one objective data in cooperation with local subjective data of the local subjective database and define, for an associated customer associated with the remote processing system, a first customer partiality vector as a function of both the at least one objective data and the local subjective data, wherein the first customer partiality vector comprises a magnitude value and corresponding representative directional characterization; and identify based on the first customer partiality vector a product having a product partiality vector that has a threshold alignment with the first customer partiality vector.

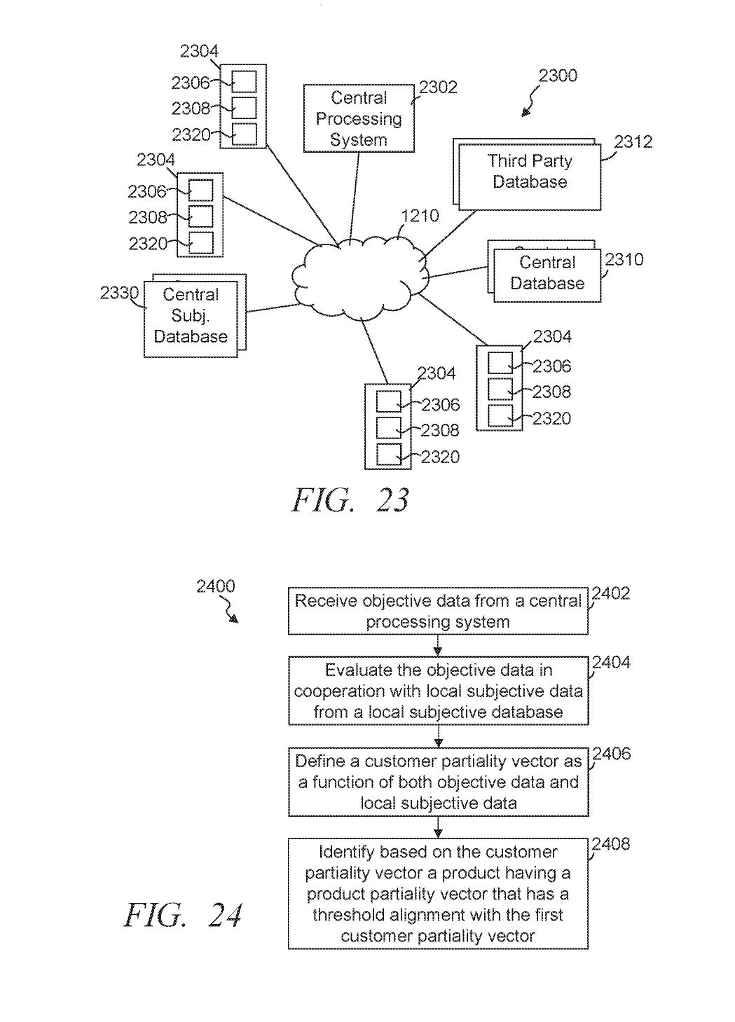

FIG. 23 illustrates a simplified block diagram of an exemplary distributed retail partiality vector system 2300, in accordance with some embodiments. The partiality vector system includes a vectorization central processing system 2302 as part of or communicatively coupled over the distributed computer and/or communication network 1210 with a distributed and decentralized processing system and a distributed and decentralized computer memory and/or storage, which are generally referred to herein as databases but the memory is not limited to databases and/or the organization of stored data is not restricted to a single database structure. The distributed processing system utilizes processor and/or computer processing through a plurality of customer (or potential customer) computing devices 2304 that are geographically distributed. Each customer computing device 2304 includes at least one computing device control circuit and/or processing system 2306 and local tangible computer memory 2308 locally storing data and implementing at least part of the distributed subjective database. In some embodiments, each of the local memory 2308 store at least a local subjective database storing, for a corresponding one of the multiple different customers each associated with at least one of the customer computing devices 2304, a set of multiple subjective customer data corresponding to subjective characteristics associated with product purchase decisions by the respective customer.

In some embodiments, the partiality vector system 2300 further includes and/or is communicatively coupled with one or more central memory and/or databases 2310 storing customer, product and/or retail data. In some instances, the central databases 2310 are maintained by the central processing system 2302. Additionally or alternatively, one or more third party databases 2312 may be part of the distributed and decentralized computer memory and maintain objective and/or subjective product data (e.g., retail product manufacturer objective databases, product supplier objective databases, retail product manufacturer subject databases, etc.). The central database and/or the third part databases store at least objective data corresponding to a plurality of different products offered for sale through one or more retail facilities. In some embodiments, the central database and/or local objective databases implemented in corresponding customer computing devices 2304 further store objective data corresponding to the multiple customers and at least the multiple customers' activities associated with product purchasing.

The system applying one or more rules cooperatively utilizes objective data and the subjective data in defining one or more customer partiality vectors. In some embodiments, customer partiality vectors and/or product partiality vectors are defined according to:

\vec{V}=f(Objective Data,Subjective Data),

within a multi-dimensional space. As such, at least some partiality vectors (\vec{V}) have one or more objective aspects or characteristics, and subjective aspects or characteristics. Further, some embodiments apply weightings to one or more of the objective data and/or one or more of the subjective data. The weightings can correspond to an importance or magnitude that the data has relative to the relative order associated with that partiality vector.

In some embodiments, the distributed and decentralized computer memory can include the local memory 2308 of multiple different customer computing devices 2304, and in some instances includes central subjective memory and/or databases 2330. This decentralized subjective memory may maintain product subjective data comprising one or more sets of one or more subjective product data corresponding to subjective characteristics associated with product purchase decisions by the respective customer, and/or subjective customer data, where some of that subjective customer data may be received from the customer computing devices 2304. Such subjective data and/or characteristics can correspond to, for example, aesthetics, how emotions may be affected, contextual, world views, affinities, flavor preferences, simplicity versus complexity, personality traits, proactive versus last second, style sense, status conscious, risk tolerance, environmental sensitivity, natural versus synthetic, and other such subjective data. Much of the subjective data can be accumulated over time by the numerous customer computing devices evaluating information accessed by and/or inputted by the corresponding customer through communications, Internet access, data accessed, and the like.

Further, the numerous individual customer computing devices 2304 can perform contextual interpretation of information to identify subjective data, subjective characteristics, and/or associate a weighting to the subjective data and/or characteristics to be associated with the customer associated with the customer computing devices. The distributed computing device processing systems 2306 and/or the central processing system 2302 can perform contextual interpretations of information (e.g., social media, news, Internet searching, websites visited, purchases made, and/or other such information) in identifying patterns, one or more threshold numbers of references in the news, one or more threshold numbers of references in different social media sources, whether the references are positive or negative, an interpretation of a level of positive or negative reaction (e.g., based on adjectives associated with the concept being considered, source of the reference, etc.), and/or other such contextual interpretations. In some implementations, hundreds of thousands of customer computing devices (e.g., smart phones, tablets, computers, etc.) track information associated with a corresponding customer, receive information from the central processing system, and/or receive information from one or more other customer computing devices in identifying subjective parameters and accumulating data to identify a relevance and/or weighting of that subjective parameter relative to the corresponding customer (e.g., based on repeated access to a subject, numbers of instances in social media, number of related Internet searches, number of sources of information accessed related to subjective data, durations between instances, rates of repetition, etc.). For example, the processing systems can identify numbers of times and durations between times that a customer references a topic that is associated with a subjective parameter (e.g., using terms and/or accessing information that can be interpreted relative to a customer's interest and/or value relative to aesthetic, world view, etc.). As a further example, the computing device processing system 2306 can detect a corresponding customer's use of terms and phrases (e.g., ugly, beautiful, pretty, etc.), websites visited (e.g., types of magazine sites visited, clothing retailer sites, etc.), and other such information. The use of the distributed computing devices takes advantage of the large numbers of available processing systems and enables the processing to be distributed and implemented without significantly affecting the operation of the individual customer computing devices. Further, much of the data to be processed in identifying subjective information is accessed through and/or passes through these customer computing devices enabling direct access to the information.

In some embodiments, two or more of the customer computing devices 2304 and/or the central processing system 2302 can cooperate as a group and/or confirm data transfers. For example, multiple customer computing devices may be associated with a single customer and those multiple customers can utilize one or more shared, distributed ledgers or blockchain data schemes to facility information distribution, authenticate the transfer of information, provide duplicity, and/or track the distribution of information. Further, some embodiments maintain and provide access to one or more shared, distributed ledgers or blockchain data schemes. Information acquired through one or more customer computing devices may be communicated using chained blocks and a distributed ledger kept regarding the communications. The distributed ledger can be replicated among multiple customer computing devices and/or the central processing system. Some or all of the distributed ledger may be a private, while some or all of the distributed ledger may be a public scheme. The ledger entries blocks may apply a proof-of-work, proof-of-stake, proof-of-space, and/or other such authentication to achieve distributed consensus. The private ledgers may apply restricted access to authorized systems or devices. The ledger can provide access to information (e.g., subjective data and/or characteristics, objective data and/or characteristics, sensor information, operating status information other such information, and typically a combination of two or more of such information). Further, the ledger information can be accessed by multiple customer computing devices and/or the central processing system.

The objective databases, in some implementations, can maintain customer objective data, product objective data, retail facility objective data, other such objective data, and typically a combination of two or more of such objective data. The product objective data for each of the different products can include a set of objective data corresponding to each product defining objective information, characteristics, other such information, or a combination of two or more of such information. For example, objective product data may include, but is not limited to, size, weight, count, dimensions, physical attributes of product, time attributes of use of product, effort attributes of product (e.g., reduces effort by “X” amount over one or more other products), pricing to customer, location, cost to retailer, color(s), name, unique identifier information (e.g., RFID, bar code, etc.), whether product is part of a collection and/or association with one or more other products, whether the product is considered “organic” and/or complies with “organic” standards, ingredients, rate of sales (e.g., at one or more retail facilities, on-line sales, etc.), other such objective data, or a combination of two or more of such data. Further, some of the objective data may include a value that manifests in a Newtonian part of order. Some of this object product data can be used to define objective product partiality vectors.

Objective customer data may, for example, include but is not limited to customer name, home address, number of family members, customer work address, methods of payment associated with a customer, customer budget, customer spending history, customer purchase history, demographics, location of past purchases, age, gender, race, social media postings, Internet search history, Internet site history, sensory data, Internet-of-Things monitoring, routes and paths of movement, modes of transportation, physical attributes of purchased products, time attributes, effort attributes whether the customer purchases “organic” products, whether the customer purchases in bulk, purchase quantities, purchase rates, other such data, and typically a combination of two or more of such data.

Further, the distributed processing system further identifies, based on one or more customer partiality vectors that are determined based on subjective and objective data, at least one product having a product partiality vector that has a threshold alignment with at least one of the customer partiality vectors. In some embodiments, the alignment is determined based on a dot product between customer and product partiality vectors, and the result being considered relative to one or more alignment thresholds. Further, the customer computing device can initiate a purchase of the identified product and/or communicate a recommendation to the customer. The purchase may be initiated without customer authorization (e.g., based on predefined settings that authorizes the customer computing device to purchase products on the customer's behalf), or after obtaining an express authorization from the customer (e.g., through the display of one or more options on a graphical user interface displayed on the customer computing device or one or more other customer computing devices associated with the customer, through a text message, email, or the like). In some embodiments, the customer computing devices can implement code to evaluate the one or more objective data in cooperation with local subjective data from the local subjective database, and identify that the product should be purchased within a threshold period of time, and/or following a period of time.

As one non-limiting example, the customer computing device may initiate a purchase of new running shoes based on received objective data regarding when the customer associated with the customer computing device purchased running shoes, and objective data regarding a rate of deterioration of the purchased running shoe. The computing device may further access local subjective data in obtaining the customer's running distance rate per day, customer's motivation for future running activities, and/or other such subjective data. Using this objective and subjective data, one or more customer partiality vectors can be defined and/or updated. Based on at least the determined customer partiality vector and in some instances other customer partiality vectors, the customer computing device can identify a pair of running shoes that have a product partiality vectors that have threshold alignments with customer partiality vectors. For example, that customer computing device can identify a pair of running shows that are within an expected budget of the customer, consistent with the customer's desired durability, consistent with the customer's wear rate, consistent with the customer's aesthetic desires, and the like.

Some embodiments further evaluate objective data in determining a relevance and/or weighting of objective data. This relevance and/or weighting can be determined based on repetition, rates of repetition, prices paid, and other such information. The central processing system typically has better accessibility to the objective data and is configured to process such factual, objective data.

The customer computing devices can continually monitor information (e.g., sent through and/or accessed through the customer computing devices) in maintaining and/or updating the local subjective database. In some embodiments, the information can include information based on purchases by the corresponding customer. The customer computing devices can be configured to evaluate subjective characteristics of multiple product partiality vectors associated with each of multiple different products purchased by the associated customer, and update the local subjective database and/or stored customer subjective characteristics based on the subjective characteristics of the multiple product partiality vectors associated with each of multiple different products purchased. For example, the customer computing device can identify product partiality vectors that have a threshold subjective characteristic and add or adjust a corresponding customer subjective characteristic based on the purchase. In some instances, the adjustment can correspond to an increase or decrease of a weighting of that characteristic, increase or decrease a magnitude associated with the subjective characteristic, or other such adjustments. Similarly, the customer computing device may detect a threshold number of products purchased having a second threshold partiality vector and/or partiality vectors having third threshold subjective characteristics, and adjust one or more corresponding customer subjective characteristics. As another example, the customer computing device may identify a change in product partiality vectors and/or subjective characteristics of one or more product partiality vectors corresponding with different products being purchased than in the past (e.g., a threshold change over a threshold period of time). In one non-limiting example, the customer computing device may detect a change in importance of aesthetics to the corresponding customer based on differences in purchases of clothes having a first average aesthetic subjective characteristic of one or more product partiality vectors compared to purchases of clothes last year having a second average aesthetic subjective characteristic of one or more product partiality vectors.

Further, the customer computing device 2304 and/or the central processing system 2302 may modify one or more customer partiality vectors based on the updated local subjective database. Again, at least some customer partiality vectors are defined by the subjective characteristics. As such, in some embodiments the customer computing device may modify a customer partiality vector based on the updated local subjective database updated based on the subjective characteristics of the multiple product partiality vectors associated with each of multiple different products purchased.

Some embodiments additionally or alternatively update the subjective database and/or subjective customer characteristics over time based on the corresponding customer's non-purchase activities. The customer computing devices typically comprise one or more sensor systems 2320 and/or communicatively couple with sensor systems (referred to below generally as sensors) that capture and communicate sensor data to the computing device processing system 2306. The sensors can include but are not limited to cameras, location detection systems (e.g., GPS, wireless signal triangulation, etc.), accelerometers, altimeters, text recognition sensor, heart rate monitors, step monitors, smart watches, and the like. Further, the customer computing devices can receive additional data or sensor data from one or more applications operating on the customer computing device, such as an Internet browser application, an application that monitors Internet access, communications and/or data communicated via the Internet, social media applications, and other such applications. The customer computing devices can identify, based on sensor data from one or more sensors, multiple different activities performed by the associated customer. The activities can be substantially any relevant activity, such as but not limited to different types of exercise (e.g., yoga, bicycling, running, hiking, working, attending a class, eating, at a social event, etc.). In some applications, the customer computing device can utilize sensor data from multiple different sensors, calendars, Internet data and/or other sources of information.

Further, some of the information may be learned over time based on historic activities. For example, a customer computing device may include or have access to a calendar of scheduled activities for the customer and based on a calendar event, a current time and date, location information, and heart rate information, the customer computing device can identify a customer is exercising in an exercise class. As another example, a smart watch may detect the motion of putting on beauty products and create a signature of movements that could measure the time spent. The more time spent by the customer the greater indication of value for the subjective attribute of beauty, and the computing device can adjust one or more corresponding subjective partiality vectors accordingly. In some instances, effort is measured in time spent imposing order and purchasing products and/or services that reduce required effort. The computing device can measure the effort exerted by the customer (e.g., calories burned per unit time), with more calories burned corresponding to greater subjective value and/or more time spent corresponding to a greater subjective value. Further, the computing device processing system can obtain and evaluate subjective characteristics associated with each of the multiple different purchasing and/or non-purchasing activities performed by the associated customer. Based on the evaluation of the subjective characteristics, the computing device processing system can update the local subjective database based on the subjective characteristics associated with the activities.

In some implementations, one or more of the central objective databases and/or distributed databases may be updated based on customer purchases. The central processing system 2302 can access the multiple product partiality vectors associated with each of the multiple different products purchased by the associated customer. The objective characteristics of the multiple product partiality vectors can be evaluated, and the central and/or local objective databases 2310 can be updated corresponding to the associated customer based on the objective characteristics of the multiple product partiality vectors associated with each of multiple different purchased products. The updates may include adjusting a weighting associated with an objective characteristic, removing an objective characteristic, adding an objective characteristic, associating an objective characteristic with a customer partiality vector (e.g., such that subsequent determinations of that customer partiality vector is determined based on the objective characteristic), other such adjustments, or a combination of two or more of such adjustments. Further, the central processing system, in some embodiments, may modify one or more customer partiality vector corresponding to the associated customer based on objective characteristics of the multiple product partiality vectors associated with each of the multiple different products purchased by the associated customer.

Some embodiments in setting and/or adjusting customer partiality vectors identify and/or weight product partiality based on a corresponding cost to the product for a respective product partiality vector. For example, a customer may have an objective partiality vector for clean clothes, a subjective partiality vector of a fresh aroma of clean clothes, a subjective partiality vector for maintaining the environment, and a subjective partiality vector of a caring attitude towards animals, along with others. For this customer, a laundry detergent is likely to be more appealing or valuable if chemicals used for the fresh smell are biodegradable, and still further more appealing of valuable if the detergent were manufactured without testing using animals. A portion of the cost of the laundry detergent can be attributed to each partiality vector (e.g., how well it cleans; smells wonderful; friendly to the environment; animals were not used in testing; etc.). The customer might pay twice as much for such a laundry detergent over other laundry detergents that get clothes just as clean but do not have the scent, are more harmful to the environment and/or was tested using animals. The biodegradable aroma may add 50% of that premium, and the other 50% may come from the extra cost to the company to develop a product without testing on animals. The cost allocation of the objective partiality vector for clean clothes out of a $10 purchase price might be $5, while $2.50 allocated for each of subjective biodegradable aroma partiality vector, and non-animal testing partiality vector. The magnitude of a partiality vector may be determined and adjusted over time based on a ratios of cost relative to the customer's disposable income of the customer the customer repeatedly willing to allocate for different product partiality vectors of different products.

The distributed processing comprises the multiple distributed customer computing devices 2304. Each of the customer computing devices 2304 is configured to receive at least one objective data from the central processing system that communicatively couples with the central database 2310 and/or the third party databases 2312 that store at least objective data corresponding to a plurality of different products offered for sale through the corresponding retail facility. Further, the databases may further store objective data corresponding to each of multiple customers, which can include data of at least the multiple customers' activities associated with product purchasing (e.g., products purchased, rates of purchase, durations between purchase, prices paid, quantities purchased, changes over time of products purchased, etc.). Accordingly, the objective data received at a customer computing device may be objective product data and/or objective customer data.

The customer computing devices 2304 are further configured to evaluate the received objective data in cooperation with local subjective data of the local subjective database maintained local on the customer computing device. Based on the evaluation, the customer computing device can define, for the customer associated with the customer computing device, one or more customer partiality vectors as a function of both the objective data and the local subjective data. The defined customer partiality vector comprises a magnitude value and corresponding representative directional characterization based on the received objective data and the local stored subjective data.

Some embodiments further implement a distributed and decentralized customer partiality vector database that includes a plurality of local partiality vector databases each coupled with a respective one of the customer computing devices. In some implementations, the local partiality vector databases are further maintained within the local computer memory 2308. Accordingly, each of multiple customer computing devices 2304 implement software that causes the customer computing devices to maintain a set of multiple customer partiality vectors associated with the corresponding customer and that are stored in the decentralized customer partiality vector database. The locally stored customer partiality vectors can be partiality vectors determined by the local customer computing device processing system 2306 and/or partiality vectors determined by the central processing system. Again, the set of customer partiality vectors are directed quantities that each have both the magnitude value and the directional characterization, with the directional characterization representing a determined order imposed upon material space-time by a particular partiality and the magnitude value represents a determined magnitude of a strength of the belief, by the corresponding customer, in a benefit that comes from that imposed order. Further, many if not all of the customer partiality vectors of the set are determined based on both a set of one or more subjective data accessed from the corresponding local subjective database, and a set of one or more objective data accessed from the central objective database and/or the local objective database.

The determined partiality vectors can be used by the customer computing devices 2304 and/or the central processing system 2302 to identify based on the customer partiality vectors one or more products having a product partiality vector that has a threshold alignment with the one or more customer partiality vectors.

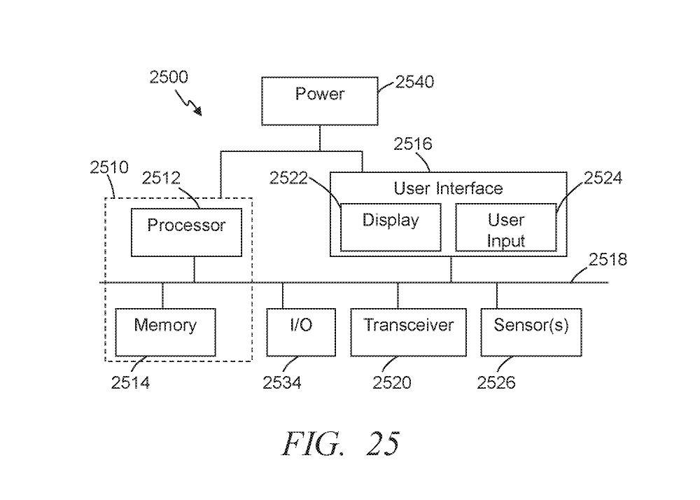

FIG. 24 illustrates a simplified flow diagram of a process 2400 of maintaining distributed partiality vectors, in accordance with some embodiments. In step 2402, one or more objective data is received at a customer computing device 2304 from the central processing system 2302. Again, distributed and decentralized processing system comprises the multiple customer computing devices, with each of the multiple customer computing devices being associated with one of multiple customers. The central processing system is communicatively coupled with the central objective database 2310 storing objective data corresponding to a plurality of different products offered for sale through a corresponding retail facility, and objective data corresponding to multiple customers and at least the multiple customers' activities associated with product purchasing.

In step 2404, the objective data is evaluated in cooperation with local subjective data from a local subjective database 2308 of the customer computing device 2304. The local subjective database is part of the distributed and decentralized customer subjective database that stores, for each of the multiple customers, a set of multiple subjective customer data corresponding to subjective characteristics associated with product purchase decisions by the respective customer. In step 2406, one or more customer partiality vectors are defined for the customer associated with the customer computing device. In some instances, one or more of the customer partiality vectors are defined as a function of both one or more objective data and one or more local subjective data. As described above, a customer partiality vector comprises a magnitude value and corresponding representative directional characterization. In step 2408, a product is identified based on one or more of the defined customer partiality vectors, where the identified product has a product partiality vector that has a threshold alignment with the one or more defined customer partiality vectors.

Some embodiments maintain a set of multiple customer partiality for each of the multiple customers that are stored in the distributed and decentralized customer partiality vector database. In some instances, each of the set of multiple customer partiality vectors are maintained through corresponding customer computing devices. Further, the customer partiality vector database comprises a plurality of local partiality vector databases each within a local memory 2308 of a respective one of the customer computing devices 2304. As described above, the set of customer partiality vectors are directed quantities that each have both the magnitude value and the directional characterization, with the directional characterization representing a determined order imposed upon material space-time by a particular partiality and the magnitude value represents a determined magnitude of a strength of the belief, by the corresponding customer, in a benefit that comes from that imposed order. Further, in defining the set of customer partiality vectors, each the partiality vectors are defined based on both a set of at least one subjective data accessed from the corresponding local subjective database, and a set of at least one objective data accessed from the central objective database.

In some embodiments, subjective characteristics of multiple product partiality vectors associated with each of multiple different products purchased by the associated customer are evaluated. For example, the evaluation can include identifying a pattern of subjective characteristics, identifying a set of related subjective characteristics, identifying the same subjective characteristic corresponding to a threshold number of the different products, identifying an increase in purchased products having the same or similar subjective characteristics, and the like. The local subjective database can be updated based on the evaluation and subjective characteristics of the multiple product partiality vectors associated with each of multiple different products purchased. For example, based on the evaluation, one or more changes to weightings of subjective characteristics can be adjusted (e.g., identifying that a customer is purchasing more products having an increased association or emphasis with aesthetics, and thus increasing a weighting of aesthetic data in determining one or more partiality vectors), one or more subjective characteristics can be added or removed from consideration relative to one or more products or types of products, and other such updating. Further, some embodiments modify one or more customer partiality vector based on the updated local subjective database updated based on the subjective characteristics of the multiple product partiality vectors associated with each of multiple different products purchased. Again, for example, when a weighting relative to subjective data and/or characteristics is increased, that can modify a partiality vector defined based on objective data as well as corresponding adjusted weighted subjective data.

Additionally or alternatively, in some implementations sensor data from one or more sensors of the customer computing device (e.g., incorporated within the customer computing device and/or coupled with the customer computing device) is received, and based on the sensor data from one or more sensors, multiple different activities performed by the associated customer can be identified. Subjective characteristics associated with each of the multiple different activities performed by the associated customer can be evaluated (e.g., identifying patterns, changes in patterns, different emphasis, and the like corresponding to one or more subjective characteristics). Based on the evaluation, the local subjective database can be updated based on the subjective characteristics associated with the activities. In some embodiments, the central processing system in implementing code can be configured to access multiple product partiality vectors associated with each of the multiple different products purchased by the associated customer. One or more objective characteristics of the multiple product partiality vectors can be evaluated. This evaluation can include, but is not limited to, identifying patterns of objective characteristics of the multiple product partiality vectors, identifying changes in emphasis of objective characteristics (e.g., customer repeatedly selecting a product that is on sale over a similar product, customer repeatedly purchasing larger quantities of one or more products, the purchase of a product not previously purchased, etc.). Based on this evaluation, the objective database can be updated corresponding to the associated customer based on the objective characteristics of the multiple product partiality vectors associated with each of multiple different products purchased (e.g., adjusting weightings, adding objective characteristics, removing objective characteristics, etc.).

Further, some embodiments modify one or more customer partiality vectors corresponding to the associated customer based on the objective characteristics of the multiple product partiality vectors associated with each of the multiple different products purchased by the associated customer and/or the updated objective database (e.g., updated objective characteristics, weightings, etc.). For example, when the weighting of an objective characteristic is adjusted, this typically results in an adjustment in magnitude and/or relative direction of one or more partiality vectors that are determined based in part on the objective characteristic. Some embodiments evaluate at least one objective data in cooperation with local subjective data from the local subjective database and identify that a product should be purchased within a threshold period of time.

Again, the distributed retail partiality vector system 2300 goes beyond merely identifying based on past purchases what a customer typically purchases as “preferences”, and instead identifies partialities that are the underlying foundations that drive a customer's decisions in selecting products and making decisions. The partiality vector system further improves the determination of partiality vectors by identifying and applying both subjective and objective data. The use of the subjective data allows the system to advance the partiality vectors beyond evaluating mere historic factual data and beyond the use of “preferences” of products as used in the past, which was determined based on a customer's repeated purchases of the same products. The subjective data used to define the partiality vectors increases the precision and accuracy of the partiality vectors taking into consideration a customer's beliefs, emotions, and other factors that change over time to more accurately identify products that the customer currently is likely to purchase and/or keep when purchased on her/his behalf.

Further, the systems, circuitry, devices, circuits, processes, methods, techniques, functionality, services, servers, sources and the like described herein may be utilized, implemented and/or run on many different types of devices and/or systems. FIG. 25 illustrates an exemplary system 2500 that may be used for implementing any of the components, circuits, circuitry, systems, functionality, apparatuses, processes, or devices of the system 1800 of FIG. 18, the method 1900 of FIG. 19, the method 2000 of FIG. 20, the distributed retail partiality vector system 2300 of FIG. 23 and/or other above or below mentioned systems or devices, or parts of such circuits, circuitry, functionality, systems, apparatuses, processes, or devices. For example, the system 2500 may be used to implement some or all of the system 1800 for collecting customer information with the control circuit being a customer collector control circuit, the inventory system 1818 with an inventory system control circuit, the item database 1806, the customer profile database 1808, the store map database 1810, the inventory system 1818, the communication device 1802, the wearable device(s) 1812, 1814, 1816, the control circuit 1301, supplier control circuit 1702, the central processing system 2302, the customer computing devices 2304, computing device processing system 2306, inventory tracking systems, point-of-sale systems, product ordering systems, and/or other such components, circuitry, functionality and/or devices. However, the use of the system 2500 or any portion thereof is certainly not required.

By way of example, the system 2500 may comprise a control circuit or processor module 2512, memory 2514, and one or more communication links, paths, buses or the like 2518. Some embodiments may include one or more user interfaces 2516, and/or one or more internal and/or external power sources or supplies 2540. The control circuit 2512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc.

Further, in some embodiments, the control circuit 2512 can be part of control circuitry and/or a control system 2510, which may be implemented through one or more processors with access to one or more memory 2514 that can store instructions, code and the like that is implemented by the control circuit and/or processors to implement intended functionality. In some applications, the control circuit and/or memory may be distributed over the communications network 1310 (e.g., LAN, WAN, Internet) providing distributed and/or redundant processing and functionality. Again, the system 2500 may be used to implement one or more of the above or below, or parts of, components, circuits, systems, processes and the like. For example, the system may implement the central processing system 2302 with the control circuit being a central control circuit, the control circuit 1301, supplier control circuit 1702, the control circuit 1804, the communication device 1802, the customer computing devices 2304, computing device processing system 2306, or other components.

The user interface 2516 can allow a user to interact with the system 2500 and receive information through the system. In some instances, the user interface 2516 includes a display 2522 and/or one or more user inputs 2524, such as buttons, touch screen, track ball, keyboard, mouse, etc., which can be part of or wired or wirelessly coupled with the system 2500. Typically, the system 2500 further includes one or more communication interfaces, ports, transceivers 2520 and the like allowing the system 2500 to communicate over a communication bus, a distributed computer and/or communication network 1310 (e.g., a local area network (LAN), the Internet, wide area network (WAN), etc.), communication link 2518, other networks or communication channels with other devices and/or other such communications or combination of two or more of such communication methods.

Further the transceiver 2520 can be configured for wired, wireless, optical, fiber optical cable, satellite, or other such communication configurations or combinations of two or more of such communications. Some embodiments include one or more input/output (I/O) ports 2534 that allow one or more devices to couple with the system 2500. The I/O ports can be substantially any relevant port or combinations of ports, such as but not limited to USB, Ethernet, or other such ports. The I/O interface 2534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensor systems 2320 and/or sensors 2526 to provide information to the system and/or sensor information that is communicated to another component, such as the central processing system 2302, customer computing device 2304, etc. The sensors can include substantially any relevant sensor, such as cameras, location detection systems, accelerometers, altimeters, text recognition sensor, heart rate monitors, step monitors, smart watches, data processing applications, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 2500 comprises an example of a control and/or processor-based system with the control circuit 2512. Again, the control circuit 2512 can be implemented through one or more processors, controllers, central processing units, logic, software and the like. Further, in some implementations the control circuit 2512 may provide multiprocessor functionality.

The memory 2514, which can be accessed by the control circuit 2512, typically includes one or more processor readable and/or computer readable media accessed by at least the control circuit 2512, and can include volatile and/or nonvolatile media, such as RAM, ROM, EEPROM, flash memory and/or other memory technology. Further, the memory 2514 is shown as internal to the control system 2510; however, the memory 2514 can be internal, external or a combination of internal and external memory. Similarly, some or all of the memory 2514 can be internal, external or a combination of internal and external memory of the control circuit 2512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 1310. The memory 2514 can store code, software, executables, scripts, data, content, lists, programming, programs, log or history data, user information, customer information, product information, and the like. While FIG. 25 illustrates the various components being coupled together via a bus, it is understood that the various components may actually be coupled to the control circuit and/or one or more other components directly.

Some embodiments compile and/or access subjective and objective data corresponding to a customer and use that information to determine value vectors as a function of both subjective data and objective data. A list of objective and subjective customer characteristics and/or factors can be compiled. These characteristics may have a hierarchy and different weightings can be applied according to the customer's partialities.

In some embodiments, a distributed retail partiality vector system, comprises a distributed and decentralized customer subjective database storing, for each of multiple different customers, a set of multiple subjective customer data corresponding to subjective characteristics associated with product purchase decisions by the respective customer; and a distributed and decentralized processing system communicatively coupled with a separate central processing system, wherein the decentralized processing system comprises: a different customer computing device associated with each of the multiple customers, and corresponding local subjective databases of a respective one of the customer computing devices and storing a corresponding set of the sets of subject customer data of the decentralized customer subjective database corresponding to one of the multiple customers, wherein each of the customer computing devices is configured to: receive at least one objective data from the central processing system communicatively coupled with a central objective database storing objective data corresponding to: a plurality of different products offered for sale through a corresponding retail facility; and multiple customers and at least the multiple customers' activities associated with product purchasing; evaluate the at least one objective data in cooperation with local subjective data of the local subjective database and define, for an associated customer associated with the customer computing device, a first customer partiality vector as a function of both the at least one objective data and the local subjective data, wherein the first customer partiality vector comprises a magnitude value and corresponding representative directional characterization; and identify based on the first customer partiality vector a product having a product partiality vector that has a threshold alignment with the first customer partiality vector.

Some embodiments provide methods of maintaining distributed partiality vectors, comprising: receiving, at a customer computing device of multiple customer computing devices of a distributed and decentralized processing system with each of the multiple customer computing devices associated with one of multiple customers, at least one objective data from a central processing system communicatively coupled with a central objective database storing objective data corresponding to: a plurality of different products offered for sale through a corresponding retail facility, and multiple customers and at least the multiple customers' activities associated with product purchasing; evaluating the at least one objective data in cooperation with local subjective data from a local subjective database of a distributed and decentralized customer subjective database storing, for each of the multiple customers, a set of multiple subjective customer data corresponding to subjective characteristics associated with product purchase decisions by the respective customer; defining, for an associated customer associated with the customer computing device, a first customer partiality vector as a function of both the at least one objective data and the local subjective data, wherein the first customer partiality vector comprises a magnitude value and corresponding representative directional characterization; and identifying based on the first customer partiality vector a product having a product partiality vector that has a threshold alignment with the first customer partiality vector.

Some embodiments provide apparatuses comprising: a memory having information stored therein regarding various characterizations of a plurality of different products; a control circuit operably coupled to the memory and configured to: use the information to form product characterization vectors for each of the plurality of different products wherein the product characterization vectors have a magnitude that represents a reduction of exerted effort associated with the corresponding product to pursue a corresponding user partiality. In some embodiments, the information includes both objective characterizing information and subjective characterizing information for at least some of the plurality of the different products. The objective characterizing information, in some embodiments, comprises at least one of: ingredients information; manufacturing locale information; efficacy information; cost information; availability information; environmental impact information. In some embodiments, the subjective characterizing information comprises at least one of: user sensory perceptions information; aesthetics information; trustworthiness information; trendiness information.

In some embodiments, the apparatus further comprises: a network interface; wherein the control circuit further operably couples to the network interface and is further configured to: receive, via the network interface, product characterization information from a third-party product testing service; use the product characterization information when forming at least some of the product characterization vectors. The control circuit, in some implementations, is further configured to: receive, via the network interface, user-based product characterization information; use the user-based product characterization information when forming at least some of the product characterization vectors. The control circuit, in some applications, is further configured to: when the product characterization information from a third-party product testing service for a particular product conflicts with the user-based product characterization information for the same particular product, automatically resolving the conflict when forming the corresponding product characterization vector using at least one pre-determined rule. In some embodiments, the at least one-predetermined rule comprises a rule based upon at least one of: age of the information; a number of user reviews upon which the user-based product characterization information is based; information regarding historical accuracy of information from a particular information source; social media; trending analysis; strength of brand awareness.

In some implementations, the control circuit is further configured to: use the information to form a plurality of product characterization vectors for a same characterization factor for a same one of the plurality of different products to correspond to different usage circumstances of that same one of the plurality of different products. In some embodiments, control circuit can form the plurality of product characterization vectors for the same characterization factor for that same one of the plurality of different products to have differing magnitudes from one another to correspond to different reductions of exerted effort associated with that product under the different usage circumstances. The different usage circumstances, in some applications, include at least one of: different geographic regions of usage; different levels of user expertise; different levels of expected use.

Some embodiments provide methods comprising: by a control circuit operably coupled to a memory having information stored therein regarding various characterizations of a plurality of different products: using the information to form product characterization vectors for each of the plurality of different products wherein the product characterization vectors have a magnitude that represents a reduction of exerted effort associated with the corresponding product to pursue a corresponding user partiality. In some embodiments, the method further comprises: receiving, via a network interface, product characterization information from a third-party product testing service; using the product characterization information when forming at least some of the product characterization vectors. In some embodiments, the method further comprising: receiving, via the network interface, user-based product characterization information; using the user-based product characterization information when forming at least some of the product characterization vectors. In some embodiments, the method further comprises: when the product characterization information from a third-party product testing service for a particular product conflicts with the user-based product characterization information for the same particular product, automatically resolving the conflict when forming the corresponding product characterization vector using at least one pre-determined rule.

In some embodiments, the at least one-predetermined rule comprises a rule based upon at least one of: age of the information; a number of user reviews upon which the user-based product characterization information is based; information regarding historical accuracy of information from a particular information source; social media; trending analysis; and strength of brand awareness. The method, in some implementations, further comprises: using the information to form a plurality of product characterization vectors for a same characterization factor for a same one of the plurality of different products to correspond to different usage circumstances of that same one of the plurality of different products. In some embodiments the forming the plurality of product characterization vectors for the same characterization factor for that same one of the plurality of different products comprises forming the plurality of product characterization vectors for the same characterization factor for that same one of the plurality of different products to have differing magnitudes from one another to correspond to different reductions of exerted effort associated with that product under the different usage circumstances. In some implementations, the different usage circumstances include at least one of: different geographic regions of usage; different levels of user expertise; different levels of expected use.

Some embodiments provide systems for collecting customer information, comprising: a communication device configured to communicate with a plurality of wearable devices, the plurality of wearable devices each comprises one or more sensors; a customer profile database storing customer partiality vectors associated with a plurality of customers; an item database storing item characteristics associated with a plurality of items; and a control circuit coupled to the communication device, the customer profile database, and the item database, the control circuit configured to: receive, via the communication device, reaction data detected by a sensor of the one or more sensors on a wearable device of the plurality of wearable devices, the wearable device worn by a customer; identify one or more items associated with the reaction data; identify one or more customer partiality vectors of the customer partiality vectors as being relevant to the one or more items based on the item characteristics associated with the one or more items retrieved from the item database; and update the one or more customer partiality vectors associated with the customer based on the reaction data and the item characteristics of the one or more items. In some implementations, each of the customer partiality vectors has a magnitude that corresponds to a determined magnitude of a strength of a belief by respective customer in an amount of good that comes from an amount of order imposed upon material space time by a corresponding particular partiality. The sensor on the wearable device, in some embodiments, comprises one or more of a heart rate sensor, a body temperature sensor, a blood oxygen level sensor, a perspiration sensor, a brain wave sensor, and a step counter. In some applications, the one or more items are identified based on one or more of a location sensor, a Radio Frequency Identification (RFID) sensor, a near field communication (NFC) sensor, an optical sensor, a camera, and short-range data transceiver on the wearable device.

In some embodiments the one or more items are identified based on at least one of a location of the wearable device within a shopping space and a store map database storing item and item advertisement locations in the shopping space. In some embodiments, the customer partiality vectors are determined based on reaction data associated with the plurality of items and aggregated over time. The control circuit, in some implementations, is further configured to: establish a baseline measurement associated with the customer based on monitoring data from the sensor on the wearable device over time. In some embodiments, the control circuit is further configured to: detect a reaction event based on comparing sensor data with the baseline measurement prior to using the sensor data as the reaction data. In some embodiments, the one or more customer partiality vectors of the customer partiality vectors associated with the customer are updated based on a degree of difference between the reaction data and the baseline measurement. The control circuit, in some applications, is further configured to: determine whether the reaction data corresponds to a positive or a negative reaction; and update the one or more customer partiality vectors of the customer partiality vectors associated with the customer based on whether the reaction data corresponds to a positive or a negative reaction.

Some embodiments provide methods for collecting customer information, comprising: receiving, via a communication device configured to communicate with a plurality of wearable devices comprising sensors, reaction data detected by a sensor of a wearable device worn by a customer; identifying, by a control circuit coupled to the communication device, one or more items associated with the reaction data; identifying, by the control circuit, one or more customer partiality vectors as being relevant to the one or more items based on item characteristics associated with the one or more items retrieved from an item database; and updating the one or more customer partiality vectors associated with the customer stored in a customer profile database based on the reaction data and the item characteristics of the one or more items. In some embodiments, each of the one or more customer partiality vectors has a magnitude that corresponds to a determined magnitude of a strength of a belief by respective customer in an amount of good that comes from an amount of order imposed upon material space time by a corresponding particular partiality.

The sensor on the wearable device, in some embodiments, comprises one or more of a heart rate sensor, a body temperature sensor, a blood oxygen level sensor, a perspiration sensor, a brain wave sensor, and a step counter. In some embodiments, the one or more items are identified based on one or more of a location sensor, a Radio Frequency Identification (RFID) sensor, a near field communication (NFC) sensor, an optical sensor, a camera, and short-range data transceiver on the wearable device. In some embodiments, the one or more items are identified based on at least one of a location of the wearable device within a shopping space and a store map database storing item and item advertisement locations in the shopping space. In some applications, the one or more customer partiality vectors are determine based on the reaction data associated with a plurality of items aggregated over time. The method, in some embodiments, further comprises establishing a baseline measurement associated with the customer based on monitoring data from the sensor on the wearable device over time. In some embodiments, the method further comprises detecting a reaction event based on comparing sensor data with the baseline customer measurement prior to using the sensor data as the reaction data. In some embodiments, one or more vectors of the one or more customer partiality vectors associated with the customer are updated based on a degree of difference between the reaction data and the baseline measurement. The method, in some embodiments, further comprises: determining whether the reaction data corresponds to a positive or a negative reaction; and updating one or more vectors of the one or more customer partiality vectors associated with the customer based on whether the reaction data corresponds to a positive or a negative reaction.

Some embodiments provide an apparatus for collecting customer information, comprising: a non-transitory storage medium storing a set of computer readable instructions; and a control circuit configured to execute the set of computer readable instructions which causes the control circuit to: receive, via a communication device configured to communicate with a plurality of wearable devices comprising sensors, reaction data detected by a sensor of a wearable device worn by a customer; identify one or more items associated with the reaction data; identify one or more customer partiality vectors as being relevant to the one or more items based on item characteristics associated with the one or more items retrieved from an item database; and update the one or more customer partiality vectors associated with the customer stored in a customer profile database based on the reaction data and the item characteristics of the one or more items.

Some embodiments provide a rule-based apparatus to identify a possible consumer partiality, comprising: a memory having stored therein information for each of a plurality of individual consumers, wherein the information includes a plurality of different partiality vectors for at least some of the individual consumers; a control circuit operably coupled to the memory and configured to: select a particular one of the individual consumers to provide a selected consumer; identify a set of the partiality vectors that are known to apply to the selected consumer to provide a base set of the partiality vectors; use a rule-based approach to filter the information to identify a plurality of other consumers who share the base set of the partiality vectors and who also have at least one other partiality vector; use a rule-based approach to identify, as a function of the at least one other partiality vector, at least one candidate partiality vector that may be applicable to the selected consumer. In some embodiments, the memory comprises a plurality of physically-distributed memories. In some applications, at least one of the plurality of physically-distributed memories is operated by a first entity and a second one of the plurality of physically-distributed memories is operated by a second entity that is different from the first entity. In some embodiments, the control circuit is configured to select the particular one of the individual consumers to provide the selected consumer as a function, at least in part, of: a user-entered consumer-selection criterion; a predetermined geographic area; a predetermined demographic data value; a requirement that the selected consumer have at least a predetermined number of the partiality vectors associated therewith; a predetermined vocational status; a predetermined religious belief system; a predetermined political affiliation.

In some embodiments, the control circuit is configured to identify the set of the partiality vectors that are known to apply to the selected consumer to provide the base set of the partiality vectors by, at least in part, requiring that the partiality vectors associated with the selected consumer include at least one predetermined partiality vector. In some embodiments, the control circuit is configured to identify the set of the partiality vectors that are known to apply to the selected consumer to provide the base set of the partiality vectors by, at least in part, requiring that the partiality vectors associated with the selected consumer include at least two predetermined partiality vectors. In some applications, the control circuit is configured to identify the set of the partiality vectors that are known to apply to the selected consumer to provide the base set of the partiality vectors by, at least in part, requiring that the partiality vectors associated with the selected consumer include at least three predetermined partiality vectors. In some embodiments, the control circuit is configured to use the rule-based approach to filter the information to identify the plurality of other consumers who share the base set of the partiality vectors and who also have at least one other partiality vector by using the rule-based approach to filter the information to identify a plurality of other consumers share the base set of the partiality vectors and who also have at least two other partiality vectors. In some embodiments, the rule-based approach that identifies the at least one candidate partiality vector that may be applicable to the selected consumer comprises, at least in part, a rule requiring that at least a certain number of the plurality of other consumers who share the base set of the partiality vectors also all share the at least one candidate partiality vector. In some applications, the certain number of the plurality of consumers comprises a majority of the plurality of other consumers. In some embodiments, the rule-based approach to filter the information to identify the plurality of other consumers who share the base set of the partiality vectors and who also have at least one other partiality vector further comprises a rule-based approach to filter the information to identify a plurality of other consumers who: share the base set of the partiality vectors; who also have at least one other partiality vector; and who also do not have at least one other predetermined partiality vector.

Some embodiments provide rule-based methods to identify a possible consumer partiality, comprising: by a control circuit: accessing a memory having stored therein information for each of a plurality of individual consumers, wherein the information includes a plurality of different partiality vectors for at least some of the individual consumers; selecting a particular one of the individual consumers to provide a selected consumer; identifying a set of the partiality vectors that are known to apply to the selected consumer to provide a base set of the partiality vectors; using a rule-based approach to filter the information to identify a plurality of other consumers who share the base set of the partiality vectors and who also have at least one other partiality vector; using a rule-based approach to identify, as a function of the at least one other partiality vector, at least one candidate partiality vector that may be applicable to the selected consumer. In some embodiments, the selecting the particular one of the individual consumers to provide the selected consumer comprises selecting the particular one of the individual consumers to provide the selected consumer as a function, at least in part, of: a user-entered consumer-selection criterion; a predetermined geographic area; a predetermined demographic data value; a requirement that the selected consumer have at least a predetermined number of the partiality vectors associated therewith; a predetermined vocational status; a predetermined religious belief system; a predetermined political affiliation.

In some embodiments, the identifying the set of the partiality vectors that are known to apply to the selected consumer to provide the base set of the partiality vectors comprises, at least in part, requiring that the partiality vectors associated with the selected consumer include at least one predetermined partiality vector. In some embodiments, the identifying the set of the partiality vectors that are known to apply to the selected consumer to provide the base set of the partiality vectors comprises, at least in part, requiring that the partiality vectors associated with the selected consumer include at least two predetermined partiality vectors. IN some applications, the identifying the set of the partiality vectors that are known to apply to the selected consumer to provide the base set of the partiality vectors comprises, at least in part, requiring that the partiality vectors associated with the selected consumer include at least three predetermined partiality vectors. In some embodiments, using the rule-based approach to filter the information to identify the plurality of other consumers who share the base set of the partiality vectors and who also have at least one other partiality vector comprises using the rule-based approach to filter the information to identify a plurality of other consumers share the base set of the partiality vectors and who also have at least two other partiality vectors. In some embodiments, the rule-based approach that identifies the at least one candidate partiality vector that may be applicable to the selected consumer comprises, at least in part, a rule requiring that at least a certain number of the plurality of other consumers who share the base set of the partiality vectors also all share the at least one candidate partiality vector. In some embodiments, the certain number of the plurality of consumers comprises a majority of the plurality of other consumers. In some embodiments, the rule-based approach to filter the information to identify the plurality of other consumers who share the base set of the partiality vectors and who also have at least one other partiality vector further comprises a rule-based approach to filter the information to identify a plurality of other consumers who: share the base set of the partiality vectors; who also have at least one other partiality vector; and who also do not have at least one other predetermined partiality vector.

Some embodiments provide distributed retail partiality vector systems, comprising: a distributed and decentralized customer subjective database storing, for each of multiple different customers, a set of multiple subjective customer data corresponding to subjective characteristics associated with product purchase decisions by the respective customer; and a distributed and decentralized processing system communicatively coupled with a separate central processing system, wherein the decentralized processing system comprises: a different customer computing device associated with each of the multiple customers, and corresponding local subjective databases of a respective one of the customer computing devices and storing a corresponding set of the sets of subject customer data of the decentralized customer subjective database corresponding to one of the multiple customers, wherein each of the customer computing devices is configured to: receive at least one objective data from the central processing system communicatively coupled with a central objective database storing objective data corresponding to: a plurality of different products offered for sale through a corresponding retail facility; and multiple customers and at least the multiple customers' activities associated with product purchasing; evaluate the at least one objective data in cooperation with local subjective data of the local subjective database and define, for an associated customer associated with the customer computing device, a first customer partiality vector as a function of both the at least one objective data and the local subjective data, wherein the first customer partiality vector comprises a magnitude value and corresponding representative directional characterization; and identify based on the first customer partiality vector a product having a product partiality vector that has a threshold alignment with the first customer partiality vector. The system, in some embodiments, further comprises: a distributed and decentralized customer partiality vector database comprising a plurality of local partiality vector databases each coupled with a respective one of the customer computing devices, wherein each of the customer computing devices is configured to maintain a set of multiple customer partiality vectors stored in the decentralized customer partiality vector database; wherein the set of customer partiality vectors are directed quantities that each have both the magnitude value and the directional characterization, with the directional characterization representing a determined order imposed upon material space-time by a particular partiality and the magnitude value represents a determined magnitude of a strength of the belief, by the corresponding customer, in a benefit that comes from that imposed order; wherein each of the customer partiality vectors of the set is determined based on both a set of at least one subjective data accessed from the corresponding local subjective database, and a set of at least one objective data accessed from the central objective database.

In some embodiments, each of the customer computing devices is configured to evaluate subjective characteristics of multiple product partiality vectors associated with each of multiple different products purchased by the associated customer, and update the local subjective database based on the subjective characteristics of the multiple product partiality vectors associated with each of multiple different products purchased. In some embodiments, each of the customer computing devices is configured to modify a second customer partiality vector based on the updated local subjective database updated based on the subjective characteristics of the multiple product partiality vectors associated with each of multiple different products purchased. In some embodiments, each of the customer computing devices comprise at least one sensor, wherein each of the customer computing devices is configured to: identify, based on sensor data from the at least one sensor, multiple different activities performed by the associated customer; evaluate subjective characteristics associated with each of the multiple different activities performed by the associated customer; and update the local subjective database based on the subjective characteristics associated with the activities.

The system, in some embodiments, further comprises the central processing system configured to access the multiple product partiality vectors associated with each of the multiple different products purchased by the associated customer, evaluate objective characteristics of the multiple product partiality vectors, and update the objective database corresponding to the associated customer based on the objective characteristics of the multiple product partiality vectors associated with each of multiple different products purchased. In some embodiments, the central processing system is configured to modify at least a second customer partiality vector corresponding to the associated customer based on the objective characteristics of the multiple product partiality vectors associated with each of the multiple different products purchased by the associated customer. In some embodiments, each of the customer computing devices is configured to evaluate the at least one objective data in cooperation with local subjective data from the local subjective database and identify that the product should be purchased within a threshold period of time.

Some embodiments provide methods of maintaining distributed partiality vectors, comprising: receiving, at a customer computing device of multiple customer computing devices of a distributed and decentralized processing system with each of the multiple customer computing devices associated with one of multiple customers, at least one objective data from a central processing system communicatively coupled with a central objective database storing objective data corresponding to: a plurality of different products offered for sale through a corresponding retail facility, and multiple customers and at least the multiple customers' activities associated with product purchasing; evaluating the at least one objective data in cooperation with local subjective data from a local subjective database of a distributed and decentralized customer subjective database storing, for each of the multiple customers, a set of multiple subjective customer data corresponding to subjective characteristics associated with product purchase decisions by the respective customer; defining, for an associated customer associated with the customer computing device, a first customer partiality vector as a function of both the at least one objective data and the local subjective data, wherein the first customer partiality vector comprises a magnitude value and corresponding representative directional characterization; and identifying based on the first customer partiality vector a product having a product partiality vector that has a threshold alignment with the first customer partiality vector. The method, in some embodiments, further comprises: maintaining, through each of the customer computing devices and associated with a corresponding one of the multiple customers, a set of multiple customer partiality vectors stored in a distributed and decentralized customer partiality vector database comprising a plurality of local partiality vector databases each within a respective one of the customer computing devices; wherein the set of customer partiality vectors are directed quantities that each have both the magnitude value and the directional characterization, with the directional characterization representing a determined order imposed upon material space-time by a particular partiality and the magnitude value represents a determined magnitude of a strength of the belief, by the corresponding customer, in a benefit that comes from that imposed order; wherein each of the customer partiality vectors of the set is defined based on both a set of at least one subjective data accessed from the corresponding local subjective database, and a set of at least one objective data accessed from the central objective database.

In some embodiments, the method further comprises: evaluating subjective characteristics of multiple product partiality vectors associated with each of multiple different products purchased by the associated customer; and updating the local subjective database based on the subjective characteristics of the multiple product partiality vectors associated with each of multiple different products purchased. In some embodiments, the method further comprises: modifying a second customer partiality vector based on the updated local subjective database updated based on the subjective characteristics of the multiple product partiality vectors associated with each of multiple different products purchased. The method, in some applications, further comprises: identifying, based on sensor data from at least one sensor of a first customer computing device, multiple different activities performed by the associated customer; valuating subjective characteristics associated with each of the multiple different activities performed by the associated customer; and updating the local subjective database based on the subjective characteristics associated with the activities. In some embodiments, the method further comprising: accessing, by the central processing system, the multiple product partiality vectors associated with each of the multiple different products purchased by the associated customer; evaluating objective characteristics of the multiple product partiality vectors; and updating the objective database corresponding to the associated customer based on the objective characteristics of the multiple product partiality vectors associated with each of multiple different products purchased. In some embodiments, the method further comprises: modifying at least a second customer partiality vector corresponding to the associated customer based on the objective characteristics of the multiple product partiality vectors associated with each of the multiple different products purchased by the associated customer. In some implementations, the method further comprises: evaluating the at least one objective data in cooperation with local subjective data from the local subjective database and identify that the product should be purchased within a threshold period of time.

Some embodiments provide apparatuses, comprising: a memory having stored therein: information including partiality information for each of a plurality of persons in the form of a plurality of partiality vectors for each of the persons wherein the partiality vector has at least one of a magnitude and an angle that corresponds to a magnitude of the person's belief in an amount of good that comes from an order associated with that partiality; and vectorized characterizations for each of a plurality of products, wherein each of the vectorized characterizations indicates a measure regarding an extent to which a corresponding one of the products accords with a corresponding one of the plurality of partiality vectors. In some embodiments the apparatus further comprises: a control circuit operably coupled to the memory and configured to compare a particular one of the partiality vectors for a particular one of the plurality of persons to each of a plurality of the vectorized characterizations to thereby identify a particular one of the plurality of products that best accords with the particular one of the partiality vectors. The control circuit, in some implementations, is configured to compare the particular one of the partiality vectors to each of the plurality of the vectorized characterizations using vector dot product calculations. The partiality information, in at least some embodiments, include values, preferences, aspirations, and affinities. In some embodiments, the apparatus further comprises: a control circuit operably coupled to the memory and configured as a state engine that uses the partiality vectors and the vectorized characterizations to identify at least one product to present to a customer.

In some embodiments the apparatus further comprises: a control circuit operably coupled to the memory and configured to use the partiality vectors and the vectorized characterizations to identify at least one product to present to the customer by, at least in part: using the partiality vectors and the vectorized characterizations to define a plurality of solutions that collectively form a multi-dimensional surface; selecting the at least one product from the multi-dimensional surface. The control circuit, in some instances, is further configured to use the partiality vectors and the vectorized characterizations to identify at least one product to present to the customer by, at least in part: accessing other information for the customer comprising information other than partiality vectors; using the other information to constrain a selection area on the multi-dimensional surface from which the at least one product can be selected. In some embodiments, the other information comprises objective information.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; and 62/485,045 filed Apr. 13, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory having information stored therein regarding various characterizations of a plurality of different products;
a control circuit operably coupled to the memory and configured to:
use the information to form product characterization vectors for each of the plurality of different products wherein the product characterization vectors have a magnitude that represents a reduction of exerted effort associated with the corresponding product to pursue a corresponding user partiality.

2. The apparatus of claim 1 wherein the information includes both objective characterizing information and subjective characterizing information for at least some of the plurality of the different products.

3. The apparatus of claim 2 wherein the objective characterizing information comprises at least one of:
ingredients information;
manufacturing locale information;
efficacy information;
cost information;
availability information;
environmental impact information.

4. The apparatus of claim 2 wherein the subjective characterizing information comprises at least one of:
user sensory perceptions information;
aesthetics information;
trustworthiness information;
trendiness information.

5. The apparatus of claim 1 further comprising:
a network interface;
wherein the control circuit further operably couples to the network interface and is further configured to:
receive, via the network interface, product characterization information from a third-party product testing service;
use the product characterization information when forming at least some of the product characterization vectors.

6. The apparatus of claim 5 wherein the control circuit is further configured to:
receive, via the network interface, user-based product characterization information;
use the user-based product characterization information when forming at least some of the product characterization vectors.

7. The apparatus of claim 6 wherein the control circuit is further configured to:
when the product characterization information from a third-party product testing service for a particular product conflicts with the user-based product characterization information for the same particular product, automatically resolving the conflict when forming the corresponding product characterization vector using at least one pre-determined rule.

8. The apparatus of claim 7 wherein the at least one-predetermined rule comprises a rule based upon at least one of:
age of the information;
a number of user reviews upon which the user-based product characterization information is based;
information regarding historical accuracy of information from a particular information source;
social media;
trending analysis;
strength of brand awareness.

9. The apparatus of claim 1 wherein the control circuit is further configured to:
use the information to form a plurality of product characterization vectors for a same characterization factor for a same one of the plurality of different products to correspond to different usage circumstances of that same one of the plurality of different products.

10. The apparatus of claim 9 wherein the control circuit can form the plurality of product characterization vectors for the same characterization factor for that same one of the plurality of different products to have differing magnitudes from one another to correspond to different reductions of exerted effort associated with that product under the different usage circumstances.

11. The apparatus of claim 10 wherein the different usage circumstances include at least one of:
different geographic regions of usage;
different levels of user expertise;
different levels of expected use.

12. A method comprising:
by a control circuit operably coupled to a memory having information stored therein regarding various characterizations of a plurality of different products:
using the information to form product characterization vectors for each of the plurality of different products wherein the product characterization vectors have a magnitude that represents a reduction of exerted effort associated with the corresponding product to pursue a corresponding user partiality.

13. The method of claim 12 further comprising:
receiving, via a network interface, product characterization information from a third-party product testing service;
using the product characterization information when forming at least some of the product characterization vectors.

14. The method of claim 13 further comprising:
receiving, via the network interface, user-based product characterization information;
using the user-based product characterization information when forming at least some of the product characterization vectors.

15. The method of claim 14 further comprising:
when the product characterization information from a third-party product testing service for a particular product conflicts with the user-based product characterization information for the same particular product, automatically resolving the conflict when forming the corresponding product characterization vector using at least one pre-determined rule.

16. The method of claim 15 wherein the at least one-predetermined rule comprises a rule based upon at least one of:
age of the information;
a number of user reviews upon which the user-based product characterization information is based;
information regarding historical accuracy of information from a particular information source;
social media;
trending analysis; and
strength of brand awareness.

17. The method of claim 12 further comprising:
using the information to form a plurality of product characterization vectors for a same characterization factor for a same one of the plurality of different products to correspond to different usage circumstances of that same one of the plurality of different products.

18. The method of claim 17 wherein forming the plurality of product characterization vectors for the same characterization factor for that same one of the plurality of different products comprises forming the plurality of product characterization vectors for the same characterization factor for that same one of the plurality of different products to have differing magnitudes from one another to correspond to different reductions of exerted effort associated with that product under the different usage circumstances.

19. The method of claim 18 wherein the different usage circumstances include at least one of:
different geographic regions of usage;
different levels of user expertise;
different levels of expected use.
